(19) United States
(12) Patent Application Publication
(10) Pub. No.: US 2016/0206513 A1
(43) Pub. Date: Jul. 21, 2016

(54) Method for the fabrication of multi-layered micro-containers for drug delivery

(71) Applicant: DANMARKS TEKNISKE UNIVERSITET, Kgs. Lyngby (DK)

(72) Inventors: Johan NAGSTRUP, Copenhagen Ø (DK); Stephan Sylvest KELLER, Vaerløse (DK); Anja BOISEN, Birkerød (DK); Ritika Singh PETERSEN, Gentofte (DK)

(21) Appl. No.: 14/913,649

(22) PCT Filed: Sep. 1, 2014
(86) PCT No.: PCT/EP2014/068525

§ 371 Date: Feb. 22, 2016

(30) Foreign Application Priority Data
Sep. 1, 2013 (EP) 13182542.4
Sep. 1, 2013 (EP) 13182543.2
Sep. 2, 2013 (EP) 13182705.7

(51) Int. Cl. A61J 3/07; B29C 59/02

(52) U.S. Cl. CPC A61J 3/078; B29C 59/026; B29L 2031/753

(57) ABSTRACT

The present invention relates to mass production of micro-containers containing an active ingredient and methods for manufacturing micro-containers containing an active ingredient.

### FIELD OF THE INVENTION

The present invention relates to mass production of micro-containers containing an active ingredient and methods for manufacturing micro-containers containing an active ingredient.

The present invention further relates to techniques for preparing individual polymer microstructures, such as micro-containers, in particular methods of preparing individual polymer structures without having to remove a residual layer.

### BACKGROUND OF THE INVENTION

The pharmaceutical industry is facing several obstacles in developing oral drug candidates. This is primarily due to the nature of the discovered drug candidates that often show poor solubility, low permeability across the gastro intestinal epithelium and are subjected to degradation before absorption in the intestine resulting in low bioavailability. Advances in micro technology and pharmaceutical engineering have led to the proposition of micro-containers as carriers for oral drug delivery. Such containers can be used for oral administration and are able to protect the drug from degradation. Importantly micro-containers can enable unidirectional release at the site of absorption thus increasing the bioavailability of the drugs.

There is thus a need in the art for techniques for preparing individual polymer microstructures, such as the micro-containers described above.

State-of-the art micro-containers are fabricated using photolithography and classical microfabrication materials. The micro-containers are individually filled using hydrogels involving several process steps such as deposition, cross-linking, washing and swelling. One drawback of using microfabrication methods for fabrication of micro-containers is that it is a multistep process that complicates mass production.

Nagstrup et al. (2011) “3D micro structuring of biodegradable polymers”, Microelectronic Engineering 88, 2342-2344 describes 3D microstructures fabricated in biodegradable polymer films with a thickness of 105 μm. The polymer microstructures are fabricated using hot embossing. These 3D microstructures will have to undergo a drug loading step to prepare micro-containers containing a drug.

Nagstrup et al. (2012) “Micro-containers with Solid Polymer Drug Matrix for Oral Drug Delivery”, Abstract Proceeding from the 16^{th} International Conference on Miniaturized Systems for Chemistry and Life Sciences, μTAS 2012, describe micro-containers fabricated in SU-8 by a two-step photolithography process and a micro-container filling process comprising embossing a polymer/drug matrix into the micro-containers, removing the carrier wafer, etching of polymer/drug matrix and mechanical release of containers.

Consequently, there is a need in the art for improved and alternative methods of mass producing micro-containers and loading them with drugs, in particular in large scale, such as wafer scale and roll-to-roll scale, and preferably without significant loss of the drug, as well as producing such micro-containers in the form of individual micro-containers which eliminates the need removal of the residual layer after embossing, and at the same time allows for release of the discrete microstructures, such as micro-containers, also as explained in the following.

With respect to preparing individual polymer microstructures, such as the microcontainers.

Kuduva-Raman-Thanumoorthy and Yao (2009) “Hot Embossing of Discrete Microparts”, Polymer Engineering and Science; describes a through-thickness embossing stamp with a rubber-assisted ejection mechanism. After the embossing step, the microstructure is stuck inside the stamp. Because it is a through-thickness embossing stamp, it is possible to release the microstructure by pressing a rubber pad against one of the sides of the through-thickness embossing stamp. The thrusting force from the rubber pad during ejection provided a similar function as that in a punching mechanism. This method has the advantage that the individual microstructures can be released without using oxygen plasma etch or other equivalent means. One drawback is that the technique requires a through-thickness embossing stamp, which makes it difficult to prepare some shapes, such as micro-containers.

Heckele and Durand (2001) “Microstructured Through-holes in Plastic Films by Hot Embossing”, Proc. of 2^{nd} euspen International Conference, 196; describes production of plastic films with through-holes by hot embossing. These plastic films are not discrete microstructures or microcontainers, rather they can be characterised as interconnected microstructures, or as microriddles. The microriddle is prepared by sandwiching two different plastic materials, and then hot embossing the sandwiched layers with a stamp so that during the hot embossing step, only the upper film is penetrated completely by the stamp, and the lower film is penetrated only to the degree required. After separation the upper film is structured with through-holes. One drawback of this method is that during the moulding process, the behaviour of the sandwich should be that of a homogeneous material, which limits the applicability of this method.

Rapp et al. (2009) “Hot punching on an 8 inch substrate as an alternative technology to produced holes on a large scale”, DTIP 2009 of Mems & MOEMS, 1-3 April, Rome, Italy; describes a hot punching process used to create a secondary tool as complementary form to the primary moulding tool and after the creation of the secondary tool the primary substrate is placed between the primary and the secondary tool, which is then hot punched by the same stamp in order to create holes. Rapp et al. prepares riddles, and is not concerned with the preparation of discrete microstructures or micro-containers.

Ryu et al. (2006) “Microfabrication Technology of Biodegradable Polymers for Interconnecting Microstructures”, J. Microelectromechanical Systems Vol. 15(6), 1457-1465; describes problems associated with the release of interconnected microstructures due to mechanical interlocking.

With respect to preparation of individual polymer microstructures. There is thus a need in the art for techniques for preparing individual polymer microstructures, such as microstructures without through-holes, for example micro-containers. In particular there is a need in the art for embossing techniques that eliminates the need removal of the residual layer after embossing, and at the same time allows for release of the discrete microstructures, such as micro-containers.

### SUMMARY OF THE INVENTION

The present invention was made in view of the prior art, and one object of the present invention is to provide a method that enables manufacturing of drug loaded micro-containers on wafer scale and/or roll-to-roll scale.

To solve the problem, the present invention provides a method for manufacturing one or more micro-container(s) containing an active ingredient comprising the steps of: a) preparing a multi-layered film comprising at least a core layer and a barrier layer, wherein the core layer comprises at least the active ingredient or wherein the core layer is configured to accept the active ingredient; b) subjecting the multi-layered film to a hot embossing step using an embossing stamp having protrusions that allows for generation of the one or more micro-container(s) containing an active ingredient, or containing a core layer that is configured to accept the active ingredient, such that the barrier layer partially encloses the core layer; c) when the core layer is configured to accept the active ingredient—providing the active ingredient to the core layer.

That is, the inventors of the present invention in a first aspect of the invention found that a multilayer film comprising a barrier layer and a core layer can be moulded into a micro-container containing the active ingredient on a wafer scale or roll-to-roll scale using a hot embossing technique. The invention provides a simplification of the manufacturing process, by reduction of the process steps to prepare drug filled micro-containers.

In some embodiments of the present invention, the method additionally comprises under a) the multi-layered film is deposited on an elastically deformable layer, which does not form part of the one or more micro-container(s), and wherein under b) the depth of the protrusions of the embossing stamp that defines the outer shape of the one or more micro-containers is higher than the thickness of the multi-layered film under step a) thus allowing the embossing stamp to penetrate all the way through the multi-layered film under step a) and into the elastically deformable layer.

That is, the inventors of the present invention have found that it is possible to release microstructures stuck in the cavity of an embossing stamp after embossing. There is a prejudice in the art that such stuck microstructures are impossible to get out in one piece, and only efforts to prepare interconnected microstructures, such as microriddles have been attempted. The manufacture of individual drug-filled containers in a single step provides a process amenable to large scale production of drug-filled containers, hitherto unseen in the art.

In some embodiments of the present invention, the multi-layered film is deposited on a handling substrate, and comprise the following sequence of deposited layers on top of the handling substrate: i) a release layer; ii) optionally an enteric layer; iii) optionally a mucoadhesive layer; iv) a core layer comprising at least the active ingredient or a core layer configured to accept the active ingredient; v) a barrier layer.

In some embodiments of the present invention the handling substrate is essentially flat with respect to each individual micro-container or microstructure. While a roll in a roll-to-roll setting is not flat per se, since the micro-containers or microstructures are small compared to the circumference of the roll, it will be experienced as being essentially flat with respect to each individual micro-container or microstructure. In some embodiments the handling substrate does not have convex and/or concave protrusions with respect to the individual micro-containers or microstructures.

In some embodiments of the present invention, the multi-layered film is prepared on a substrate using spin coating.

In some embodiments of the present invention, the embossing stamp has protrusions that allows for the generation of one or more micro-container(s), wherein the bottom of the one or more micro-container(s) is flat, curved, such as a hemisphere, or is a corner of a geometrical figure.

In some embodiments of the present invention, the embossing stamp has protrusions that allows for the generation of one or more micro-container(s) having an outer shape, which resembles a shape selected from the list consisting of: a circular and/or elliptical cylinder, a circular and/or elliptical cone, a circular and/or elliptical half-capsule, a circular and/or elliptical conical frustum, a wedge, a pyramid, a cube, a rectangular cuboid, a prism such as a triangular, pentagonal, hexagonal, heptagonal, octagonal, or polygonal prism.

In some embodiments of the present invention, the core material additionally comprises a mucoadhesive polymer.

In some embodiments of the present invention, the active ingredient is selected from the list consisting of: small organic molecules, proteins, peptides, vitamins, antibodies, antibody fragments, vaccines, RNA, DNA, antibiotics or combinations thereof.

In some embodiments of the present invention, wherein the barrier layer is made out of a material having a T_{g} of between −100 to 100° C. and a Tₘ between 35 and 250° C., and where T_{g}<Tₘ.

In some embodiments of the present invention, the barrier layer is biodegradable.

In some embodiments of the present invention, the barrier layer is made out of polylactic acid (PLLA), polycaprolactone (PCL), polylactic acid (PLA), polyglycolic acid (PGA), hydroxypropylmethyl cellulose (HPMC), polymethacrylate (PMMA), Eudragits (Poly(methacylic acid-co-methyl methacrylate), ethyl cellulose (EC), polyvinyl alcohol (PVA), polyvinylpyrollidone (PVP), polyethylene glycol (PEG), polyethylene glycol methacrylate (PEGMA), polyethylene glycol dimethacrylate (PEGDMA), poly(lactic-co-glycolic acid) (PGLA), polyacrylic acid (PAA), or co-polymers of at least one of the above polymers or monomeric units in the above polymers.

In some embodiments of the present invention, the embossing stamp has protrusions that allows for the generation of one or more micro-container(s), wherein each of the micro-containers has an outer shape comprising a width and a height of ≦9000 μm, such as ≦5000 μm, ≦2500 μm, ≦1000 μm, ≦900 μm, ≦800 μm, ≦700 μm, ≦600 μm, ≦500 μm, ≦400 μm, ≦300 μm, ≦250 μm, ≦200 μm, ≦150 μm, ≦100 μm, ≦50 μm.

In some embodiments of the present invention, the protrusions on the embossing stamp allow the manufacture of at least 60000 micro-containers in a single hot embossing step.

Another aspect of the present invention is one or more micro-container(s) obtainable according to the methods of the present invention.

Another aspect of the present invention is one or more micro-container(s) (101) containing an active ingredient, and having an outer shape comprising a bottom (102), one or more sides (103) and an opening (104), where the bottom (102) and one or more sides (103) have one or more layer thicknesses (110, 111, 112), and defines a volume, the volume being at least partially filled with a core material comprising at least one active ingredient; the micro-container having a width (w) to height (h) ratio (w/h) of ≦3; characterized in that the average layer thickness of the sides (111, 112) are less than the average layer thickness of the bottom (110) of the micro-container.

In some embodiments of the present invention, the layer thickness of part of the sides that are closer to the opening of the micro-container (112) has a layer thickness smaller than the layer thickness of the sides closer to the bottom of the micro-container (111) and/or smaller than the layer thickness of the bottom of the micro-container (110).

In some embodiments of the present invention, the bottom of the micro-container is flat, curved, such as a hemisphere, or is a corner of a geometrical figure

In some embodiments of the present invention, the outer shape of the micro-container resembles a shape selected from the list consisting of: a circular and/or elliptical cylinder, a circular and/or elliptical cone, a circular and/or elliptical half-capsule, a circular and/or elliptical conical frustum, a wedge, a pyramid, a cube, a rectangular cuboid, a prism such as a triangular, pentagonal, hexagonal, heptagonal, octagonal, or polygonal prism.

In some embodiments of the present invention, the active ingredient provided in the micro-container is selected from the list consisting of: small organic molecules, proteins, peptides, vitamins, antibodies, antibody fragments, vaccines, RNA, DNA, antibiotics or combinations thereof.

In some embodiments of the present invention, the outer shape of the micro-container is made out of a material having a T_{g} of between −100 to 100° C. and a Tₘ between 35 and 250° C., and where T_{g}<Tₘ.

In some embodiments of the present invention, the micro-container is made out of a biodegradable polymer.

In some embodiments of the present invention, the micro-container is made out of: polycaprolactone (PCL), polylactic acid (PLA), polyglycolic acid (PGA), hydroxypropylmethyl cellulose (HPMC), polymethacrylate (PMMA), Eudragits (Poly(methacylic acid-co-methyl methacrylate), ethyl cellulose (EC), polyvinyl alcohol (PVA), polyvinylpyrollidone (PVP), polyethylene glycol (PEG), polyethylene glycol methacrylate (PEGMA), polyethylene glycol dimethacrylate (PEGDMA), poly(lactic-co-glycolic acid) (PGLA), polyacrylic acid (PAA), or co-polymers of at least one of the above polymers or monomeric units in the above polymers.

In some embodiments of the present invention, each individual micro-container has a width and a height of ≦9000 μm, such as ≦5000 μm, ≦2500 μm, ≦1000 μm, ≦900 μm, ≦800 μm, ≦700 μm, ≦600 μm, ≦500 μm, ≦400 μm, ≦300 μm, ≦250 μm, ≦200 μm, ≦150 μm, ≦100 μm, ≦50 μm.

In some embodiments of the present invention, the micro-container contains an active ingredient, which is for intestinal drug delivery.

In some embodiments of the present invention, the micro-container comprises an enteric coating.

With respect to preparation of individual polymer microstructures.

The present invention was made in view of the prior art, and the object of the present invention is to provide a hot embossing method on wafer scale or roll-to-roll scale that eliminates the need removal of the residual layer after embossing, and at the same time allows for the preparation and release of the discrete microstructures as opposed to interconnected structures such as microriddles.

To solve the problem, the present invention provides a method for manufacturing one or more microstructure(s) having an outer shape comprising the steps of:
a) providing an elastically or plastically deformable layer on a substrate that does not form part of the one or more microstructure(s);
b) providing one or more layer(s) to be embossed on top of the elastically or plastically deformable layer;
c) subjecting the layers under steps a) and b) to a hot embossing step using a rigid embossing stamp having one or more protrusions defining one or more cavities that allows for generation of the one or more microstructures, wherein the depth of the one or more of the protrusions of the embossing stamp that defines the outer shape of the one or more microstructures is higher than the thickness of the one or more layer(s) to be embossed under step b) thus allowing the embossing stamp to penetrate all the way through the one or more layer(s) to be embossed under step b);
d) demoulding the one or more microstructures from in the one or more cavities in the embossing stamp by bonding the one or more microstructures onto a release layer.

That is, the inventors of the present invention have in a first aspect of the invention found that it is possible to release microstructures stuck in the cavity of an embossing stamp after embossing. There is a prejudice in the art that such stuck microstructures are impossible to get out in one piece, and only efforts to prepare interconnected microstructures, such as microriddles have been attempted.

In some embodiments of the present invention, under step c), the depth of the one or more of the protrusions of the embossing stamp that defines the outer shape of the one or more microstructures is lower than the combined heights of the layers under a) and b).

In some embodiments of the present invention, the microstructure has a non-flat top surface.

In some embodiments of the present invention, the microstructure is a micro-container.

In some embodiments of the present invention, the microstructure is without through-holes.

In some embodiments of the present invention, the embossing stamp is a closed embossing stamp.

In some embodiments of the present invention, under step d) the one or more microstructures are demoulded from in the one or more cavities in the embossing stamp by exchanging the substrate with the layers a) and b) with a substrate having a release layer, and then applying the embossing stamp to the substrate having a release layer.

In some embodiments of the present invention, the release layer is selected from the list consisting of: tape, water soluble polymer layers.

In some embodiments of the present invention, the bonding is thermal bonding, UV bonding or chemical bonding, tape adhesive bonding, ultrasonic welding, laser welding, solvent bonding.

In some embodiments of the present invention, the embossing stamp having a first stiction with regards to the one or more layer(s) to be embossed, the elastically or plastically deformable layer having a second stiction with regards to the one or more layer(s) to be embossed, characterized in that the first stiction is lower than the second stiction.

In some embodiments of the present invention, the elastically or plastically deformable layer is subjected to an oxygen plasma treatment prior to depositing the one or more layer(s) to be embossed.

In some embodiments of the present invention, the embossing stamp is coated with a stiction reducing layer, selected from the list consisting of: fluoropolymers, such as polytetrafluoroethylene (PTFE), fluorosilanes, such as per-fluoro-decyl-trichlorosilane (FDTS). In some embodiments the embossing stamp is made out of anodized aluminium, ceramics or silicone.

In some embodiments of the present invention, the elastically or plastically deformable layer is PDMS.

In some embodiments of the present invention, the embossing stamp has protrusions that allows for the generation of one or more microstructure(s) having an outer shape, which resembles a shape selected from the list consisting of: a circular and/or elliptical cylinder, a circular and/or elliptical cone, a circular and/or elliptical half-capsule, a circular and/or elliptical conical frustum, a wedge, a pyramid, a cube, a rectangular cuboid, a prism such as a triangular, pentagonal, hexagonal, heptagonal, octagonal, or polygonal prism.

In some embodiments of the present invention, the embossing stamp has protrusions that allows for the generation of one or more microstructure(s), wherein each individual microstructure has an outer shape comprising a width and a height of ≦9000 μm, such as ≦5000 μm, ≦2500 μm, ≦1000 μm, ≦900 μm, ≦800 μm, ≦700 μm, ≦600 μm, ≦500 μm, ≦400 μm, ≦300 μm, ≦250 μm, ≦200 μm, ≦150 μm, ≦100 μm, ≦50 μm.

In some embodiments of the present invention, the embossing stamp is made out of a metal or metal alloy, such as a nickel, aluminium, stainless steel, iron, brass, or wherein the embossing stamp is made out of silicon, SU-8 or glass.

With respect to the two general aspects of mass production of micro-containers containing an active ingredient and preparation of individual polymer microstructures, it will be recognised that these two general aspects and their individual embodiments can be combined to create further advantageous embodiments.

### BRIEF DESCRIPTION OF THE DRAWINGS

FIG. 1 shows in a micro-container (101), which can be used as a micro-container for an active ingredient. FIG. 1 a shows the micro-container (101) having an outer shape comprising a bottom (102), one or more sides (103) and an opening (104). FIG. 1 b shows a cross-sectional view, where the bottom (102) and one or more sides (103) have one or more layer thicknesses (110, 111, 112), where the average layer thickness of the sides (111, 112) are less than the average layer thickness of the bottom (110) of the micro-container, and where the broken line (113) shows the half-height of the micro-container.

FIG. 2 shows an illustration of a spin coating process. The solvent solution is dispensed on the center of a substrate. The substrate is then rotated at high rotation per minute. The centrifugal force pushes the solution from the center to the edge of the substrate, where excess solution is spun off. After spinning the film is dried. The procedure is repeated to make a multilayer structure.

FIG. 3 shows one embodiment of the method of the present invention, where in FIG. 3a a multi-layer preparation is shown. The layers are from the top and down: barrier layer, drug/polymer matrix, enteric coating, release layer, handling substrate. In FIG. 3b a hot embossing step is taking place, where the embossing stamp is applied to the multi-layer preparation which has been heated above the glass transition temperature (T_{g}). In FIG. 3c the embossed multilayer has been cooled to below the glass transition temperature and the embossing stamp has been removed. In FIG. 3d the micro-containers have been released from the release layer and handling substrate, and only a micro-container of the barrier layer enclosing the drug/polymer matrix with an enteric coating of the opening of the micro-container remains. The residual layer between each micro-container will in some cases be weak and rupture when handling the micro-containers. In some cases the residual layer will have to be removed using other means.

FIG. 4 shows SEM-micrographs of a nickel stamp as prepared in example 3. The protrusions are 37 μm wide at the base and 27 μm wide at the top. The height of the protrusions is 58 μm and the period is 300 μm.

FIG. 5 shows a cross-sectional view of a trench in the Silicon mould (grey) used for electroplating of the Ni stamp (in the black space) in example 3. The trench is 58 μm deep, 39 μm wide at the top of the trench and 26 μm wide at the bottom, thereby allowing for the fabrication of a stamp with positive sidewall slopes.

FIG. 6 shows a top view of embossed micropatches consisting of a drug core layer (grey) enclosed in a PCL barrier layer. The PCL polymer generally appears transparent (shown as black in the figure) while the drug/polymer matrix appears white/grey after the embossing.

FIG. 7 shows a teflon coated stamp as prepared in example 7 designed to prepare cylindrical micro-containers.

FIG. 8 shows a top view of a PLA micro-container (inside the ring) stuck in a nickel stamp (fringe of ring).

FIG. 9 shows a top view of a thermally bonded PLA micro-container on water soluble PAA release layer.

FIG. 10 shows the current state of the art where an embossing stamp leaves behind a residual film that has to be removed. The residual film helps remove the stamp from the embossed polymer film, as all the stamped structures are interconnected through a residual layer.

FIG. 11 shows an embodiment according to the present invention, where the rubber layer (elastically deformable) below the polymer film enables through-embossing, thereby leaving the embossing stamp with the micro-structures, and the residual polymer film with holes. The micro-structures are trapped in the cavity of the stamp.

FIG. 12 shows the micro-structures trapped in the stamp, where the stamp is pressed into a release layer, which could be any harvesting layer, such as tape or any polymer layer, such as a water soluble polymer layer attached through thermal bonding to the microstructures. The micro-structures are then bonded to the release layer through thermal bonding.

The bottom left illustration is in one particular embodiment, where the release layer is water soluble, thus enabling the release of the individual micro-containers from the release layer.

FIG. 13 shows an alternative to thermal bonding, where the release layer is PDMS rubber, where the stiction of the PDMS rubber has been reversibly increased by oxygen plasma treatment, and the stiction of the embossing stamp has been decreased by e.g. teflon treatment. The re-stamping of the stamp into the PDMS rubber treated with oxygen plasma (surprisingly) releases the microcontainers from the cavity of the stamp. The oxygen plasma treatment of the rubber will “wear off” thereby decreasing the stiction of the PDMS rubber over time, thereby allowing for easy release of the micro-structures.

FIG. 14 shows an embodiment where in FIG. 14a a PDMS layer (30) is applied to a Silicon wafer (40), then on top of the PDMS layer is applied a PLLA layer (20). The embossing stamp (10) is shown with protrusions suitable for preparation of micro-containers. In FIG. 14b force (50) is applied and the stamp (10) is pressed into the PLLA layer (20), which deforms (21). The PDMS layer (31) is elastically deformed. In FIG. 14c the embossing stamp (10) is removed leaving micro-containers (22) stuck inside the stamp, and the remaining PLLA layer (23) on the PDMS layer (30). In FIG. 14d force (51) is again applied to the stamp (10) containing the micro-containers (22), thermally bonding them to release layer (60), which has been applied onto another silicon wafer (40). In FIG. 9e the stamp (10) is removed from the release layer (60), and the micro-containers (22) remain on the release layer, which may subsequently be peeled off the silicon wafer (40). FIG. 14f illustrates one embodiment, where the release layer (60) is soluble in water (70) thereby releasing the individual micro-containers (22).

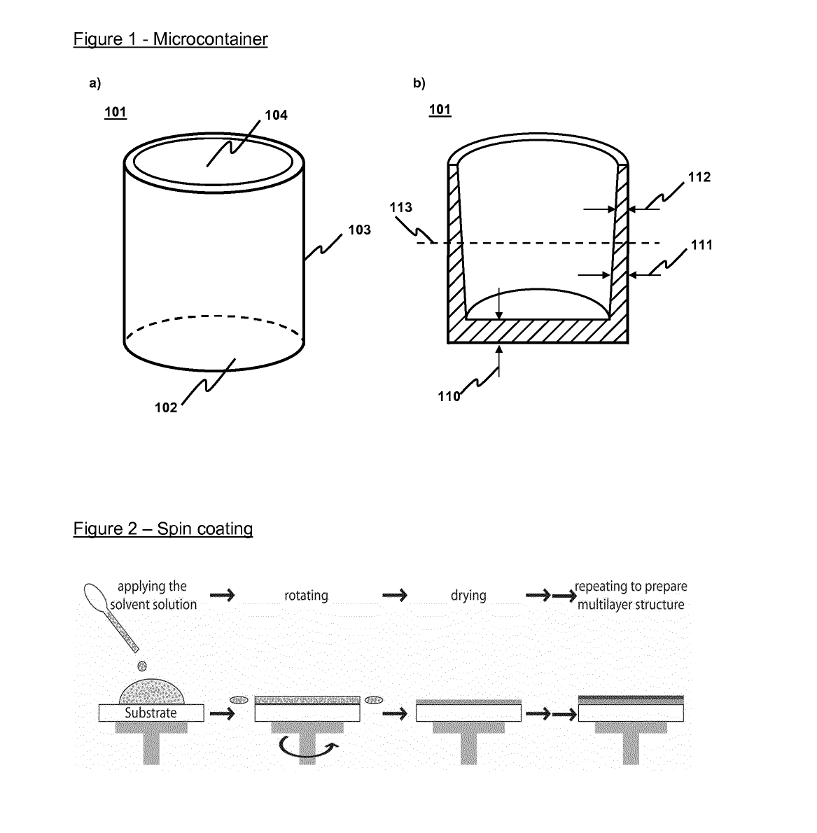

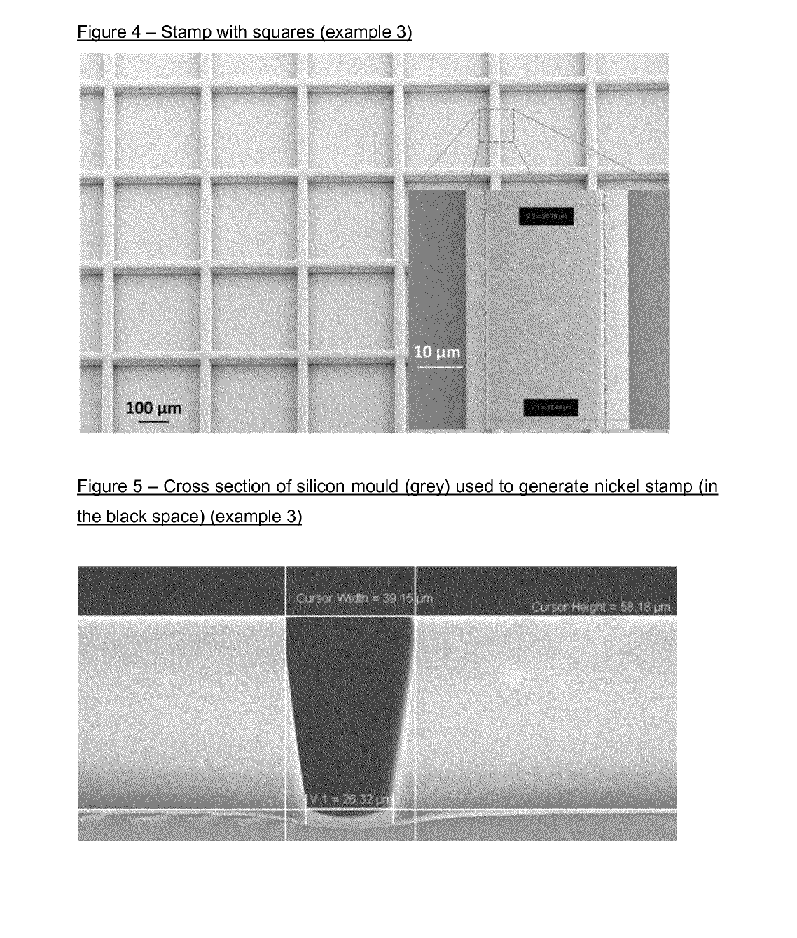

It will be recognized by the person of ordinary skill in the art, given the benefit of this disclosure that certain features shown in FIGS. 1-6 are not necessarily drawn to scale. The dimensions and characteristics of some features in the figures may have been enlarged, distorted or altered relative to other features in the figures to facilitate a better understanding of the illustrative examples disclosed herein.

### DETAILED DESCRIPTION OF THE INVENTION

In describing the embodiments of the invention specific terminology will be resorted to for the sake of clarity. However, the invention is not intended to be limited to the specific terms so selected, and it is understood that each specific term includes all technical equivalents which operate in a similar manner to accomplish a similar purpose.

The present invention, in one aspect relates to methods for manufacturing one or more micro-container(s) containing an active ingredient. In particular, the present invention, also relates to methods for manufacturing one or more microstructure(s) having an outer shape. The method allows for the manufacture of individual micro structures using hot embossing, without the need for removal of a residual layer, which is also described as another aspect in the present description.

A micro-container (101) is a receptacle which can receive and hold the active ingredient. The micro-container may have one or more openings (112). In some embodiments the micro-container has one opening (or more than one opening, where all the openings are all on one side, as e.g. the case of some multicompartmented micro-containers), which means that the container may release its contents, i.e. the active ingredient, in an essentially unidirectional manner through the opening in the micro-container. In some embodiments of the present invention, each individual micro-container has a width and a height of ≦9000 μm, such as ≦5000 μm or less than 500 μm. In some embodiments the micro-containers will have a width-to-height ratio (w/h) of to ensure a structure for an improved unidirectional release and at the same time a higher content of active ingredient compared to the release surface/opening.

The micro-container holds the active ingredient, or mixture of active ingredients. The active ingredients may be formulated with excipients, which in some embodiments may aid the preparation of the micro-container comprising the active ingredient, and/or the active ingredients may also be formulated with excipients that in some embodiments aid the delivery of the active ingredient, such as e.g.

absorption enhancers or enzyme inhibitors. For example, in the case of the active ingredient being protein or peptide based drugs the core layer may also comprise absorption enhancers and/or enzyme inhibitors.

The term active ingredient comprise any substance that alters the physiology of an animal, and also comprise any substance that may be administered to an animal for any reason, such as for example the administering of an active ingredient for diagnostic purposes, such as for example a contrast medium or prophylactic.

Active ingredients may include therapeutic, prophylactic and/or diagnostic compounds selected from the list consisting of: nutrients, such as vitamins, dietary minerals, fatty acids, amino acids, organic compounds, inorganic compounds, polysaccharides, nucleic acids, peptides, proteins, and the like

The term animal comprises animals as such, such as non-human animals, as well as mammalian animals, such as e.g. humans.

In some embodiments of the present invention, the active ingredient is selected from the list consisting of: small organic molecules, proteins, peptides, vitamins, antibodies, antibody fragments, vaccines, RNA, DNA, antibiotics or combinations thereof.

In some embodiments the one or more active ingredients may be small molecules such as enzyme inhibitors, that inhibit enzymes present in the gastro intestinal (GI) tract e.g. proteases and/or lipases. The active ingredient may be antibacterial agents that inhibit bacterial infections in the GI tract e.g. Helicobacter pylori. In some embodiments the active ingredients are for intestinal drug delivery for the treatment of diseases in the intestines such as Crohn's disease or ulcerative colitis.

Active ingredients in form of proteins may include both synthetic and natural proteins in the form of enzymes, peptide-hormones, receptors, growth factors, antibodies, signalling molecules (e.g. cytokines). In some embodiments the active ingredients may be synthetic and natural nucleic acids in the form of RNA, DNA, anti-sense RNA, triplex DNA, inhibitory RNA (RNAi), oligonucleotides and biologically active portions thereof.

The micro-container holding the active ingredient may be administered to a patient as is. The nature of micro-containers being small, an effective dose will usually require a plurality of micro-containers, which may be further formulated in a form suitable for administration to an animal, such as e.g. oral administration. Examples of suitable administration forms may be lozenge, pill, tablet, capsule, membrane, strip, liquid/suspension, patch, film, gel, spray or other suitable form.

The methods for manufacturing one or more micro-container(s) containing an active ingredient comprises the steps of: a) preparing a multi-layered film comprising at least a core layer and a barrier layer, wherein the core layer comprises at least the active ingredient or wherein the core layer is configured to accept the active ingredient; b) subjecting the multi-layered film to a hot embossing step using an embossing stamp having protrusions that allows for generation of the one or more micro-container(s) containing an active ingredient, or containing a core layer that is configured to accept the active ingredient, such that the barrier layer partially encloses the core layer; c) when the core layer is configured to accept the active ingredient—providing the active ingredient to the core layer

A multi-layered film may have at least two layers, such as two, three, four, five, six, seven, eight, nine, ten, or more. The multi-layered film comprises a core layer and a barrier layer. The core layer comprises or will later in the manufacturing process comprise the active ingredient, in which case the core layer is configured to accept an active ingredient. In some embodiments the core layer comprises the active ingredient, and in some embodiments the core layer comprises a drug matrix made out of at least one polymer and an active ingredient.

In some embodiments the core layer may be formulated as a drug matrix. The drug matrix may comprise a mixture of one or more polymer(s) and one or more drug(s)/active ingredient(s). The drug matrix may in some embodiments be prepared before the core layer is prepared/deposited by e.g. spin coating. In some embodiments a core layer configured to accept an active ingredient may be prepared/deposited first by e.g. spin coating, followed by loading the core layer with the active ingredient, thereby creating the drug matrix. In some embodiments the core layer configured to accept an active ingredient may first be loaded with the active ingredient after the preparation of the micro-container.

Accordingly, in some embodiments the present invention provides methods for manufacturing one or more micro-container(s) containing a core layer configured to accept an active ingredient comprising the steps of: a) preparing a multi-layered film comprising at least a core layer and a barrier layer, wherein the core layer is configured to accept the active ingredient; b) subjecting the multi-layered film to a hot embossing step using an embossing stamp having protrusions that allows for generation of the one or more micro-container(s) containing a core layer that is configured to accept the active ingredient, such that the barrier layer partially encloses the core layer.

Micro-containers prepared using a core layer containing a particular active ingredient are useful when one already knows which drug or active ingredient that is to be formulated in the micro-containers. The micro-containers that have a core layer configured to accept an active ingredient or drug are useful in that the drug is first added at a later stage.

The core layer can be configured to accept an active ingredient in many ways. One way may be that the core layer is made out of a material that can absorb the active ingredient, such as e.g. a hydrogel, such as polyvinylpyrrolidone (PVP) or gelatine. The active ingredient may be loaded by e.g. immersion in a fluid that contains the active ingredient, which will then be incorporated into the core layer thereby creating a drug matrix. For example the hydrogel could be impregnated using dissolution of the active ingredient in super-critical CO₂.

In some embodiments of the present invention, the core material may contain or be made out of one or more of: a hydrogel, such as polyvinylpyrrolidone (PVP), polyvinyl alcohol (PVA), polyethylene glycol (PEG), polyethylene glycol methacrylate (PEGMA), polyethylene glycol dimethacrylate (PEGDMA), polyacrylic acid (PAA), hyaluronic acid or gelatine; polylactic acid (PLA), polyglycolic acid (PGA), polycaprolactone (PCL), hydroxypropyl methylcellulose (HPMC), polyhydroxybutyrate (PHB), or polyvinyl alcohol (PVA); a mucoadhesive polymer such as chitosan, sodium alginate, carboxypolymethylene (carbomer), or carboxymethylcellulose sodium. The polymers above could also be cross-linked, and may also be co-polymers of at least one of the above polymers or monomeric units in the above polymers.

In some embodiments the polymer of the core layer may be biodegradable polymers and/or biopolymers. Biopolymers are produced by nature and examples of biopolymers may be poly-L-lactid acid (PLLA) or polyacrylic acid (PAA). Polycaprolactone (PCL) is a biodegradable polymer.

The polymer may have one or more key functions/features such as 1) being in an amorphous state to facilitate a fast dissolution of active ingredients with poor solubility. 2) The polymer may be optimized to contain as much drug as possible, thus maximizing the amount of active ingredient per volume. 3) The polymer may be chosen to allow uniform distribution of the active ingredient within the drug matrix. 4) The polymer may be chosen to allow a specific release profile of the active ingredient e.g. by dissolution of the drug matrix or diffusion of the active ingredient. A solvent may be added to the active ingredient-polymer matrix to generate a homogeneous solution to aid the preparation/deposition of the matrix as a layer; such a solvent may be DMSO, DCM, acetone, ethanol, isopropanol, and /or water.

The micro-containers may be prepared so that they are suitable for delivery to the mucosa. For example, when the core material contains a mucoadhesive polymer this would allow the micro-container to stick in an oriented manner to mucosa in the animal when administered. Accordingly, micro-containers can be prepared, which are suitable for administration to, or which are at least partially selective to the mucosa of an animal, such as e.g. the: buccal mucosa, esophageal mucosa, gastric mucosa, intestinal mucosa, nasal mucosa, olfactory mucosa, oral mucosa, bronchial mucosa, Endometrium (the mucosa of the uterus) or Penile mucosa.

The core layer could also comprise a blend or polymers/co-polymers e.g. a mucoadhesive polymer mixed with a non-mucoadhesive polymer.

The barrier layer is a layer that comprises a material that is not dissolved/degraded faster than the release of the active ingredient from the core layer. In some embodiments the barrier layer is not degraded or dissolved even for extended periods of time, when exposed to an animal body. In some embodiments the barrier layer is dissolved/degraded slower than the release of the active ingredient from the core layer, e.g. the micro-container remains intact until 100% of the active ingredient has been released, such as e.g. until 90%, until 80%, until 70%, until 60%, until 50%, until 40% or until 30% of the active ingredient has been released. Preferably the micro-container remains intact until at least 80% of the active ingredient has been released.

In some embodiments of the present invention, the barrier layer may contain or be made out of one or more of: polycaprolactone (PCL), polylactic acid (PLA), polyglycolic acid (PGA), hydroxypropylmethyl cellulose (HPMC), polymethacrylate (PMMA), Eudragits (Poly(methacylic acid-co-methyl methacrylate), ethyl cellulose (EC), polyvinyl alcohol (PVA), polyvinylpyrollidone (PVP), polyethylene glycol (PEG), polyethylene glycol methacrylate (PEGMA), polyethylene glycol dimethacrylate (PEGDMA), poly(lactic-co-glycolic acid) (PGLA), polyacrylic acid (PAA), or co-polymers of at least one of the above polymers or monomeric units in the above polymers.

Eudragits may be used as enteric coatings, and they are co-polymers comprising methyl methacrylate and ethyl acrylate.

In some embodiments of the present invention, the barrier layer is biodegradable.

In some embodiments the biodegradable polymers PLLA and PCL may be used to construct the barrier layer of the invention. An advantage of using PLLA and PCL are that these materials are approved by the Food and Drug Administration (FDA) for applications used in the human body such as for drug delivery.

Poly-L-lactic acid (PLLA) is a thermoplastic aliphatic polyester derivable from renewable resources such as corn starch, tapioca roots or sugarcane. PLLA has a melting point of 175° C. and a glass transition temperature of about 60° C. A good pattern transfer using hot embossing may be obtained at around 120° C. for PLLA.

Polycaprolactone (PCL) may be prepared by ring opening polymerization of ε-caprolactone using a catalyst. PCL can be degraded in physiological conditions such as in the human body by hydrolysis of the ester linkages. PCL has a melting point of about 60° C. and a glass transition temperature of about 60° C.

The multi-layered film comprising the core layer and the barrier layer is subjected to a hot embossing step using an embossing stamp having protrusions that allows for generation of the one or more micro-container(s), where the barrier layer partially encloses the core layer.

The hot embossing process utilizes a drop in material stiffness when the temperature of the barrier layer is heated to a temperature exceeding what is known as the glass transition temperature (T_{g}). Below the T_{g} a polymer is stiff. Once the polymer is heated to a temperature above the T_{g}, the polymer becomes softer and rubber like. If the temperature is increased further the melting point (Tₘ) is reached and the polymer becomes molten. At the temperature interval between T_{g} and Tₘ the polymer exists in the rubbery state and it is possible to shape the polymer by applying pressure on it. It is this characteristic that is utilized when applying the hot embossing technique. One way of employing a hot embossing step may be to bring a hot embossing stamp into contact with the multi-layered film, which is heated to a temperature above the T_{g} (e.g. the T_{g} of the barrier layer) and pressure is applied to the embossing stamp, forcing the protrusions of the stamp into the multi-layered film. After the stamp has been fully pressed into the multi-layered film, it is cooled to a temperature below T_{g}. The decrease in temperature below the T_{g} stiffens the multi-layered film while retaining the shape made by the protrusions of the stamp. Once the multi-layered film stiffens the stamp may be removed.

In some embodiments of the present invention, the barrier layer is made out of a material having a T_{g} of between −100 to 100° C. and a Tₘ between 35 and 250° C., and where T_{g}<Tₘ. When formulating heat sensitive active ingredients, such as e.g. some proteins and oligonucleotides, which may denature or in another way irreversibly undergo changes that reduces their effect as active ingredients, it is preferable to have a material that is susceptible to a hot embossing step under conditions that avoids these undesired changes. The barrier layer may be selected so that the T_{g} temperature is sufficiently low to avoid these undesired changes. On the other hand, in some embodiments it will be relevant to have a barrier layer with a T_{g} that is higher than e.g. the body temperature of the animal that the final micro-container it is to be administered to, to increase the rigidity of the micro-container. Accordingly, in some embodiments the T_{g} is more than 20° C., such as more than 25° C., more than 30° C., more than 35° C., more than 37° C., more than 40° C., more than 45° C., more than 50° C. In some embodiments the T_{g} is less than 120° C., such as less than 100° C., less than 90° C., less than 80° C., less than 70° C., less than 60° C., less than 50° C., less than 45° C., less than 40° C., less than 37° C., less than 35° C. In some embodiments the T_{g} range is 20-100° C., such as 20-70° C., 40-100° C., 35-70° C., 50-120° C.

The melting temperature (Tₘ) of the barrier layer may be more than 20° C., such as more than 30° C., more than 35° C., more than 37° C., more than 40° C., more than 50° C., more than 60° C., more than 70° C., more than 90° C., more than 100° C., more than 120° C. In some embodiments the Tₘ is less than 350° C., such as less than 300° C., less than 250° C., less than 200° C., less than 150° C., less than 120° C. In some embodiments the Tₘ range is 20-350° C., such as 60-350° C., 70-250° C., 80-250° C.

The embossing temperature may be between the T_{g} and the Tₘ of the barrier layer. In some embodiments the embossing temperature will be less than ½*(T_{g}+Tₘ), which may require more force and time to prepare a micro-container. The lower temperature may assist in formulations with heat sensitive active ingredients. In some embodiments the embossing temperature will be more than ½*(T_{g}+Tₘ), which may require less force and time to prepare a micro-container.

In some embodiments, in particular when the core layer comprise the active ingredient together with e.g. a polymer as described above (drug matrix), the embossing temperature may be above both the T_{g} of the barrier layer, and the apparent T_{g} of the drug matrix layer. In some embodiments the embossing temperature may be above the T_{g} of all the polymer components of the multi-layered film.

Another way to work with formulations with heat sensitive active ingredients may be to add them to a core layer configured to accept the active ingredient after it has undergone the embossing step, as also described herein. This allows for the inclusion of active ingredients, which are not compatible with the conditions of the embossing step.

The embossing stamp may have protrusions, as opposed to being flat. These protrusions assist in forming the micro-containers. With reference to FIG. 3, which shows one embodiment according to the present invention where the barrier layer is on top of the layers to be contained in the resulting micro-containers, i.e. the barrier layer is on top of the core layer. The inventors have found that when performing a hot embossing step in a multi-layered film as for example shown in FIG. 3, the layers will not break apart, but instead the outermost layer will be drawn/elongated by the protrusions of the stamp. The inventors have used this elongation feature arising from hot-embossing in a multi-layered film to prepare micro-containers, where the outermost layer envelopes the layers below and creates a micro-container with the outermost layer being in the shape of the micro-container.

In FIG. 3 a number of layers are shown. The present invention requires two layers one barrier layer and a core layer (denoted drug/polymer matrix in the embodiment of FIG. 3).

In some embodiments of the present invention, the multi-layered film may be deposited on a handling substrate, and comprise the following sequence of deposited layers on top of the handling substrate: i) a release layer; ii) optionally an enteric layer; iii) optionally a mucoadhesive layer; iv) a core layer comprising at least the active ingredient or a core layer configured to accept the active ingredient; v) a barrier layer.

The handling substrate may be any suitable substrate such as a wafer or a roll for use in a roll-to-roll production.

The release layer may be used to release the micro-containers from the substrate, and may be e.g. a water soluble polymer, such as polyvinyl alcohol (PVA), polyacrylic acid (PAA), polyethylene glycol (PEG), polyvinylpyrrolidone (PVP) or dextran. The release layer may also be omitted, and the micro-containers may be peeled or scraped off the substrate.

The multi-layered film may also comprise an enteric coating, such as for example a coating that is stable at acidic pH, but dissolves or breaks down at less acidic pH. In some embodiments an enteric coating is applied to the individual micro-containers after they have been prepared, e.g. using spray coating, or the enteric coating may be applied to a capsule or other carrier means containing a plurality of micro-containers.

The multi-layered film may also comprise a diffusion barrier layer, through which the active ingredient can diffuse. One way of preparing a diffusion layer could be by preparing a very thin layer of the same material as used for the barrier layer. This diffusion layer will not dissolve but the active ingredient would be released over a longer period of time through the diffusion layer than without the diffusion layer.

The embossing step may leave behind a thin residual layer between the embossed layer and the underlying substrate (see FIG. 3d). Such residual layers may be removed by e.g. dry etching or laser machining.

The multi-layered film may also comprise a mucoadhesive layer, which assists in bringing the micro-container closer to the mucosa, thereby directing the release of the active ingredient to the mucosa of the animal. In some embodiments the mucoadhesive is applied to the opening or open face of the micro-container, in order to arrange the opening pointing directly at the mucosa. In some embodiments the mucoadhesive coating may be part of the core layer (denoted drug matrix in the embodiment of FIG. 3), as previously described.

The micro-container may have many different shapes, as defined by the protrusions of the embossing stamp.

In some embodiments of the present invention, the embossing stamp has protrusions that allows for the generation of one or more micro-container(s), wherein the bottom of the one or more micro-container(s) is flat, curved, such as a hemisphere, or is a corner or part of a geometrical figure.

In some embodiments of the present invention, the embossing stamp has protrusions that allows for the generation of one or more micro-container(s) having an outer shape, which resembles a shape selected from the list consisting of: a circular and/or elliptical cylinder, a circular and/or elliptical cone, a circular and/or elliptical half-capsule, a circular and/or elliptical conical frustum, a wedge, a pyramid, a cube, a rectangular cuboid, a prism such as a triangular, pentagonal, hexagonal, heptagonal, octagonal, or polygonal prism. The micro-containers may have multiple compartments.

Many copies of the protrusions that generate the micro-containers may be present on one stamp, which allows for the generation of many micro-containers in one stamping process. Also the embossing stamp may be configured to be used in a roll-to-roll setup, which enables the continuous production of micro-containers.

In some embodiments of the present invention, the protrusions on the embossing stamp allows the manufacture of at least 6000 micro-containers, such as e.g. 60000 micro-containers in a single hot embossing step, e.g. such as a single revolution of a roll-stamp.

In some embodiments of the present invention, the embossing stamp has protrusions that allows for the generation of one or more micro-container(s), wherein each of the micro-containers has an outer shape comprising a width and a height of ≦9000 μm, such as ≦5000 μm, ≦2500 μm, ≦1000 μm, ≦900 μm, ≦800 μm, ≦700 μm, ≦600 μm, ≦500 μm, ≦400 μm, ≦300 μm, ≦250 μm, ≦200 μm, ≦150 μm, ≦100 μm, ≦50 μm.

In some embodiments the micro-container has an outer diameter of 200-500 μm, and may have a height of 2-70 μm. In some embodiments the wall thickness may be larger than 5 μm to increase geometrical stability and reduce buckling. In some embodiments the micro-container has a compartment size diameter of between 20-350 μm.

There are many ways to prepare the multi-layered film.

In some embodiments of the present invention, one or more of the layers in the multi-layered film are prepared using spin coating.

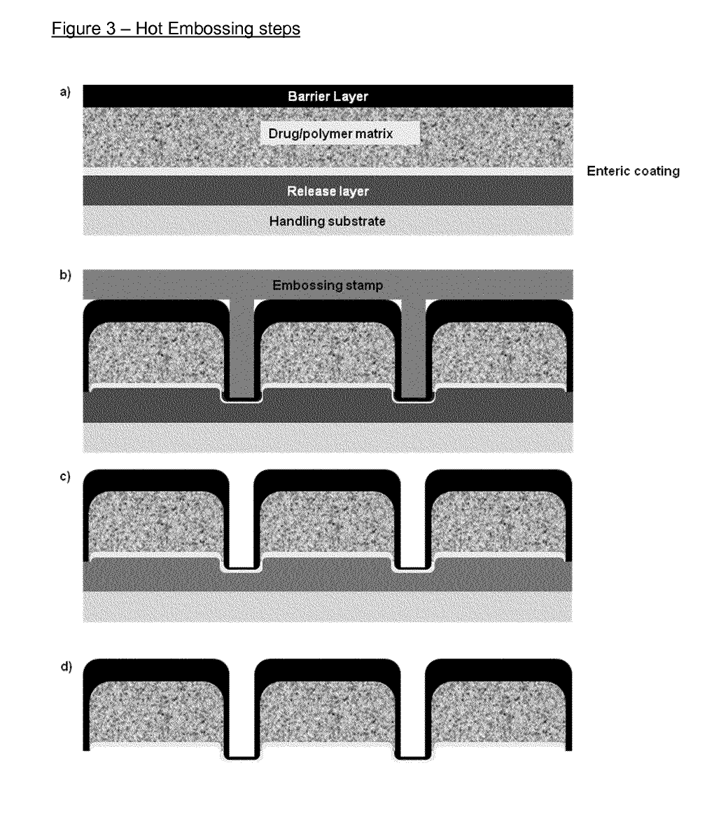

Spin coating is illustrated in FIG. 2, and is a fabrication technique, which may be used to create films that vary in thickness from tens of nanometers to hundreds of micrometers. It involves applying a solvent solution to the center of a substrate, and then rotating the substrate at high rotation per minute (RPM). The centrifugal force pushes the solution from the center to the edge of the substrate, where the excess solution is spun off the substrate. The thickness of the film is inversely proportional to the spin speed and time. After spinning the film may be dried. In some embodiments the film may be dried at room temperature and in other embodiments the film may be soft baked at an elevated temperature to remove the solvent(s). When the solvent solution comprising the polymer is dry/has evaporated it constitutes the first layer of the film and one or more additional layers can be applied by repeating the above steps to prepare a multi-layered film.

A solvent may be added to dissolve the polymer. In the case of spin coating it can be an advantage to use a solvent which does not evaporate fast at room temperature, such a solvent may be methylene dichloride or 1,3-dixolane when the polymer is PCL.

In some embodiments one or more of the individual layers of a multilayered film may be prepared by spray coating, where either the melted material/polymer is sprayed onto a substrate or previous layer, or a solution of the material/polymer is sprayed onto a substrate or previous layer. In spray coating, a polymer solution may be prepared. Pressure or ultrasonic actuation may be used to generate small polymer droplets at the aperture of the spray nozzle. The droplets may be focused on the substrate by the pressure or an additional gas flow, resulting in the depositon of a polymer film. An advantage of using spray coating technique is that it is possible to prepare thinner polymer films than by spin coating and to deposit films in a roll-to-roll setup. In preparing individual layers of film by spray coating, layers can be generated with a layer thickness below 500 nm.

Other suitable methods of preparing films include solvent casting or lamination.

In some embodiments of the present invention, the multi-layered film is prepared using spray coating or by lamination. One of the advantages of this is that such methods are well-suited to be performed on a roll-to-roll basis.

Another aspect of the present invention is one or more micro-container(s) obtainable according to the methods of the present invention.

A further aspect of the present invention is one or more micro-container(s) (101) containing an active ingredient, and having an outer shape comprising a bottom (102), one or more sides (103) and an opening (104), where the bottom (102) and one or more sides (103) have one or more layer thicknesses (110, 111, 112), and defines a volume, the volume being at least partially filled with a core material comprising at least one active ingredient or at least partially filled with a core material configured to accept at least one active ingredient; characterized in that the average layer thickness of the sides (111, 112) are less than the average layer thickness of the bottom (110) of the micro-container.

It can be seen from FIG. 3 that due to the presence of also the drug matrix, the sides of the container—being created by the embossing action—becomes thinner than the bottom, compared to hot embossing in a single layer.

In some embodiments the micro-container has a width (w) to height (h) ratio (w/h) of ≦10, such as or ≦3;

The micro-containers may have many different dimensions. For instance it may be a shallow micro-container, 30 μm high and 300 μm wide corresponding to a width to height ratio of 10; or it may be a moderately shallow micro-container, 50 μm high and 300 μm wide corresponding to a width to height ratio of 6; or it may be a micro-container, 50 μm high and 150 μm wide corresponding to a width to height ratio of 3.

In some embodiments of the present invention, the layer thickness of part of the sides that are closer to the opening of the micro-container (112) has a layer thickness smaller than the layer thickness of the sides closer to the bottom of the micro-container (111) and/or smaller than the layer thickness of the bottom of the micro-container (110).

As previously described, in some embodiments of the present invention, the bottom of the micro-container is flat, curved, such as a hemisphere, or is a corner of a geometrical figure. Furthermore, in some embodiments of the present invention, the outer shape of the micro-container resembles a shape selected from the list consisting of: a circular and/or elliptical cylinder, a circular and/or elliptical cone, a circular and/or elliptical half-capsule, a circular and/or elliptical conical frustum, a wedge, a pyramid, a cube, a rectangular cuboid, a prism such as a triangular, pentagonal, hexagonal, heptagonal, octagonal, or polygonal prism.

In some embodiments of the present invention, the micro-container contains an active ingredient, which is for intestinal drug delivery. In specific embodiments, the active ingredient for intestinal drug delivery may be selected from the list comprising: steroids, insulin, antibiotics, NSAIDs, poorly soluble drugs, proteins, peptides. Examples of active ingredients may comprise ciprofloxacin.

In some embodiments of the present invention, the micro-container comprises an enteric coating.

With respect to preparation of individual polymer microstructures.

The present invention, in one aspect relates to methods for manufacturing one or more microstructure(s) having an outer shape. The method allows for the manufacture of individual micro-structures using hot embossing, without the need for removal of a residual layer. This aspect is well-suited to be combined with the aspect described above relating to methods for manufacturing one or more micro-container(s) containing an active ingredient, as it allows for the production in one step of individual microstructures containing an active ingredient.

With respect to preparation of individual polymer microstructures. The present invention accomplishes this by a combination of hot embossing of the layers to be embossed into an elastically or plastically deformable layer in combination with a demoulding step, which demoulds the individual micro-structures which becomes stuck within the embossing stamp.

Hot embossing of individual micro-structures without a residual layer is not attempted in the art with any reasonable expectation of success, as it is understood by the skilled person in the art that such micro-structures will become stuck in the embossing stamp, without the possibility of releasing the micro-structures intact.

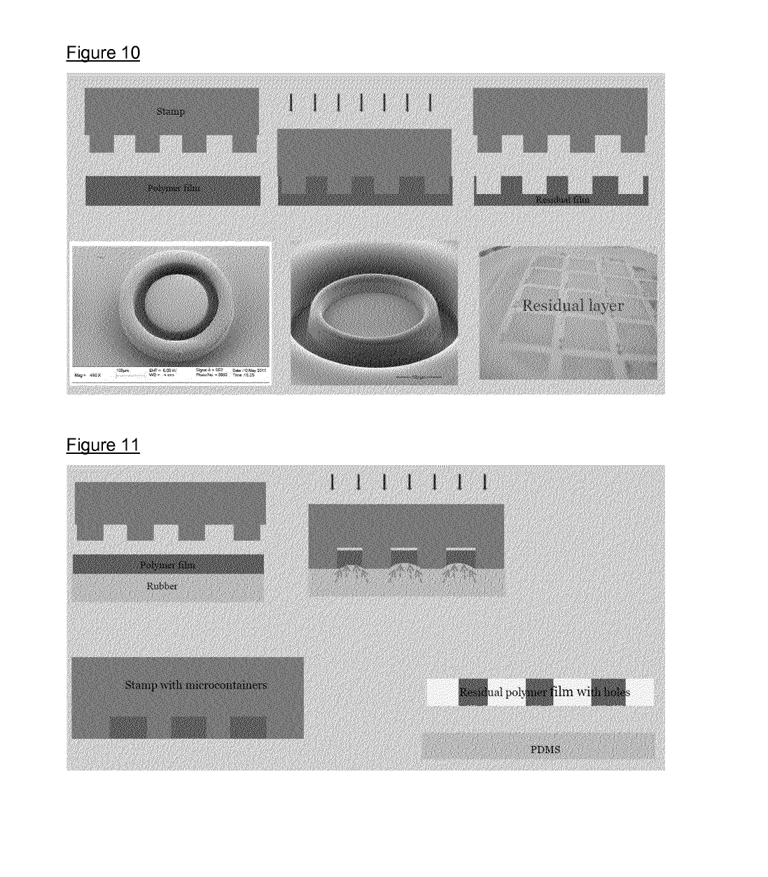

The present invention is in part based on overcoming a technical prejudice according to which until now the preparation of individual micro-structures using hot-embossing has only been attempted for making first an interconnected structure of many micro-structures, e.g. micro-structures interconnected through a residual layer (see e.g. FIG. 10), demoulding such interconnected structure and removing the residual layer, thereby preparing the individual micro-structures.

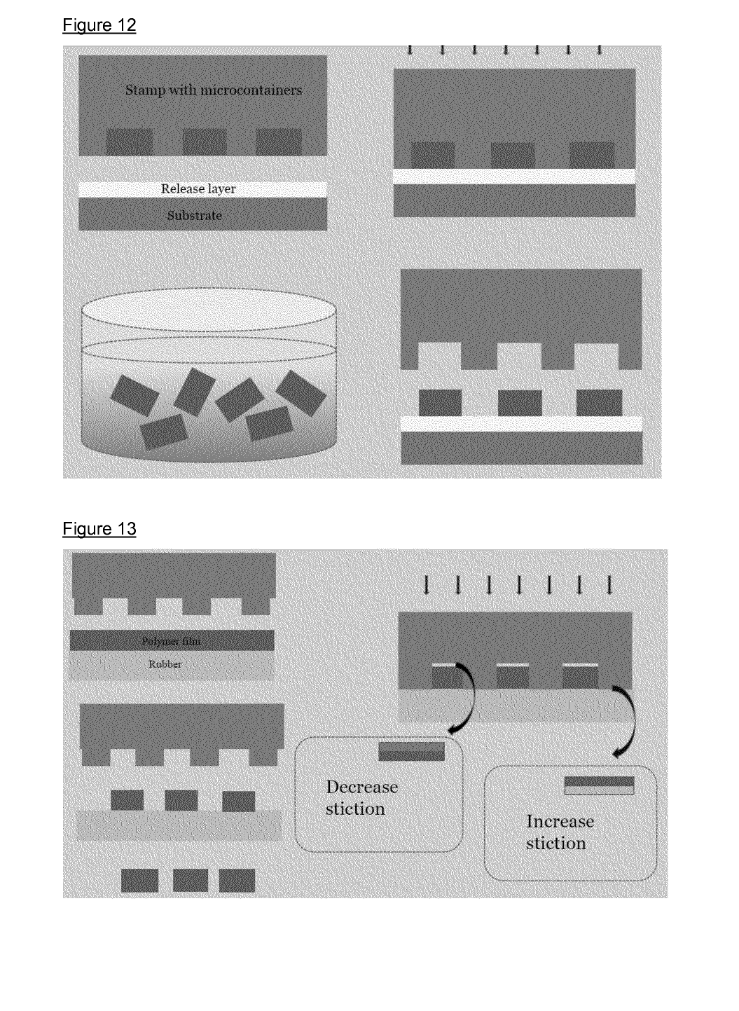

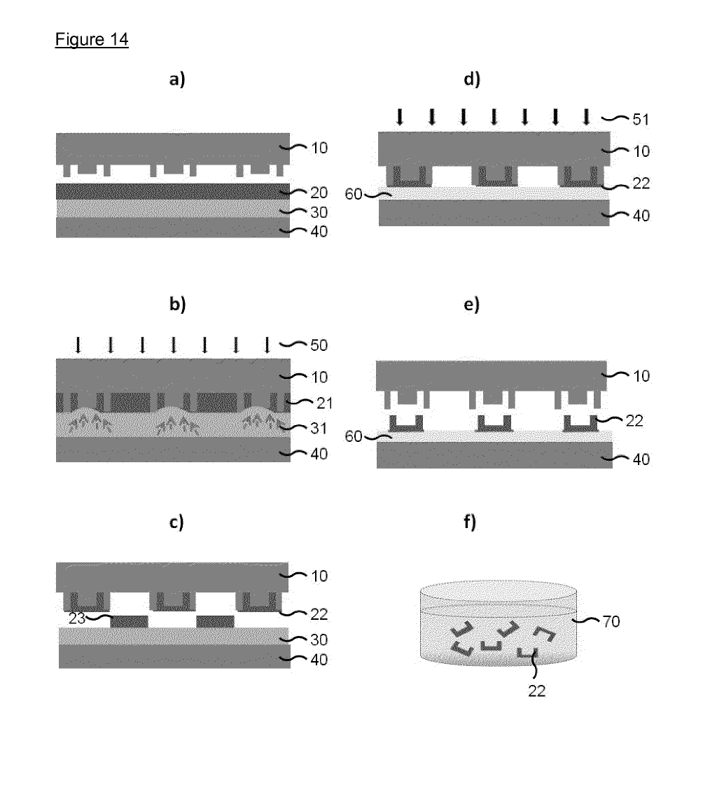

It has been found by the inventors of the present invention that individual micro-structures stuck in an embossing stamp (see e.g. FIG. 11) can in fact be demoulded under the conditions specified herein. In some embodiments the demoulding may be done by treating the elastically or plastically deformable layer so as to increase the stiction (see e.g. FIG. 13), and in another embodiment the embossing stamp containing the micro-structures are re-stamped into a release layer thereby releasing the micro-structures (see e.g. FIGS. 12 and 14).

Accordingly, in one embodiment the present invention provides methods for manufacturing one or more microstructure(s) having an outer shape, which comprises the steps of:
a) providing an elastically or plastically deformable layer on a substrate that does not form part of the one or more microstructure(s);
b) providing one or more layer(s) to be embossed on top of the elastically or plastically deformable layer;
c) subjecting the layers under steps a) and b) to a hot embossing step using a rigid embossing stamp having one or more protrusions defining one or more cavities that allows for generation of the one or more microstructures, wherein the depth of the one or more of the protrusions of the embossing stamp that defines the outer shape of the one or more microstructures is higher than the thickness of the one or more layer(s) to be embossed under step b) thus allowing the embossing stamp to penetrate all the way through the one or more layer(s) to be embossed under step b);
d) demoulding the one or more microstructures from in the one or more cavities in the embossing stamp by bonding the one or more microstructures onto a release layer.

A micro-structure is a small structure, which in some embodiments may have a width and a height of ≦9000 μm, such as ≦5000 μm or less than 500 μm.

The micro-structure may have many different outer shapes. In some embodiments of the present invention, the microstructure has a non-flat top surface. The top surface of the micro-structure is the surface that is also the top surface of the top most layer of the one or more layer(s) to be embossed.

Exemplary micro-structures that may be prepared according to the present invention are: gears, bearings, joints.

In order to prepare these micro-structures, first one or more elastically or plastically deformable layers are deposited onto a substrate. These layers should be elastically or plastically deformable under the embossing conditions. These layers will not form part of the one or more micro-structures, and should be prepared in such a way that they can be separated from the one or more layers to be embossed. In some embodiments, the one or more elastically or plastically deformable layers is PDMS, which will behave elastically. In some embodiments the elastically or plastically deformable layers is a water soluble polymer.

In some embodiments the one or more elastically or plastically deformable layers are one or more elastically deformable layer(s). The elastically deformable layers will return wholly or substantially to their original shape after being manipulated, which is an advantage if the substrate with the elastically deformable layer is to be reused.

In some embodiments of the present invention, the elastically or plastically deformable layer is selected from the list consisting of: Elastomers, such as rubbers, silicones (e.g. PDMS) and thermoplastic elastomers. In order for the elastically deformable layer to be elastically deformable at the embossing temperature, the embossing temperature should be lower than the glass transition temperature for the elastically deformable layer.

In some embodiments the one or more elastically or plastically deformable layers are one or more plastically deformable layer(s). The plastically deformable layers will not return to their original shape after being manipulated. Such deformable layers may for instance be used when it is not a requirement that the deformable layers should be reused. In order for the plastically deformable layer to be plastically deformable at the embossing temperature, the embossing temperature should be higher than the glass transition temperature (T_{g}) for the plastically deformable layer. In some embodiments, the embossing temperature should be lower than the melting temperature (Tₘ) of the plastically deformable layer.

Also in some embodiments, where there are more elastically or plastically deformable layers, they can be a mixture of elastically or plastically deformable layers.

On top of the one or more elastically or plastically deformable layer(s) is deposited one or more layers to be embossed.

In some embodiments of the present invention, the one or more layers to be embossed may contain or be made out of one or more of: polylactic acid (PLA), polycaprolactone (PCL), polylactic acid (PLA), polyglycolic acid (PGA), hydroxypropylmethyl cellulose (HPMC), polymethacrylate (PMMA), Eudragits (Poly(methacylic acid-co-methyl methacrylate), ethyl cellulose (EC), polyvinyl alcohol (PVA), polyvinylpyrollidone (PVP), polyethylene glycol (PEG), polyethylene glycol methacrylate (PEGMA), polyethylene glycol dimethacrylate (PEGDMA), poly(lactic-co-glycolic acid) (PGLA), polyacrylic acid (PAA), or co-polymers of at least one of the above polymers or monomeric units in the above polymers.

In some embodiments of the present invention, the one or more layers to be embossed are biodegradable.

In some embodiments PLA and PCL biopolymers may be used to construct the one or more layers to be embossed. An advantage of using PLA and PCL are that these materials are approved by the Food and Drug Administration (FDA) for applications used in the human body such as for drug delivery.

Poly-L-lactic acid (PLLA, also called PLA) is a thermoplastic aliphatic polyester derivable from renewable resources such as corn starch, tapioca roots or sugarcane. PLLA has a melting point of 175° C. and a glass transition temperature of about 60° C. A good pattern transfer using hot embossing may be obtained at around 120° C. for PLLA.

Polycaprolactone (PCL) may be prepared by ring opening polymerization of ε-caprolactone using a catalyst. PCL can be degraded in physiological conditions such as in the human body by hydrolysis of the ester linkages. PCL has a melting point of about 60° C. and a glass transition temperature of about −60° C.

There are many ways to prepare the multi-layered film comprising one or more elastically or plastically deformable layers and one or more layers to be embossed. The multi-layered film may have at least two layers, such as two, three, four, five, six, seven, eight, nine, ten, or more layers.

In some embodiments of the present invention, one or more of the layers are prepared using spin coating.

Spin coating is illustrated in FIG. 2, and is a fabrication technique, which may be used to create films that vary in thickness from tens of nanometers to hundreds of micrometers. It involves applying a solvent solution to the center of a substrate, and then rotating the substrate at high rotation per minute (RPM). The centrifugal force pushes the solution from the center to the edge of the substrate, where the excess solution is spun off the substrate. The thickness of the film is inversely proportional to the spin speed and time. After spinning, the film may be dried. In some embodiments the film may be dried at room temperature and in other embodiments the film may be soft baked at an elevated temperature to remove the solvent(s). Other ways to dry the film is at room temperature or baking at an elevated temperature. When the solvent solution comprising the polymer is dry/has evaporated it constitutes the first layer of the film and one or more additional layers can be applied by repeating the above steps to prepare a multi-layered film.

A solvent may be added to dissolve the polymer. In the case of spin coating it can be an advantage to use a solvent which does not evaporate fast at room temperature, such a solvent may be methylene dichloride or 1,3-dixolane when the polymer is PCL.

In some embodiments one or more of the individual layers may be prepared by spray coating, where either the melted material/polymer is sprayed onto a substrate or previous layer, or a solution of the material/polymer is sprayed onto a substrate or previous layer. In spray coating, a polymer solution may be prepared. Pressure or ultrasonic actuation may be used to generate small polymer droplets at the aperture of the spray nozzle. The droplets may be focused on the substrate by the pressure or an additional gas flow, resulting in the depositon of a polymer film. An advantage of using spray coating technique is that it is possible to prepare thinner polymer films than by spin coating. In preparing individual layers of film by spray coating, layers can be generated with a layer thickness below 500 nm.

Other suitable methods of preparing individual layers include solvent casting or lamination.

In some embodiments of the present invention, the individual layers are prepared using spray coating or lamination. One of the advantages of this is that such methods are well-suited to be performed on a roll-to-roll basis.

The multi-layered film comprising one or more elastically or plastically deformable layers and one or more layers undergo a hot embossing step using a rigid embossing stamp, which is not substantially elastically deformable under the embossing and demoulding conditions.

In some embodiments of the present invention, the embossing stamp is made out of a metal or metal alloy, such as a nickel, aluminium, stainless steel, iron, brass, or wherein the embossing stamp is made out of silicon, SU-8 or glass.

The multi-layered film is subjected to a hot embossing step using an embossing stamp having protrusions that allows for generation of the one or more micro-structures.

The hot embossing process utilizes a drop in material stiffness when the temperature of the barrier layer is heated to a temperature exceeding what is known as the glass transition temperature (T_{g}). Below the T_{g} a polymer is stiff. Once the polymer is heated to a temperature above the T_{g}, the polymer becomes softer and rubber like. If the temperature is increased further the melting point (Tₘ) is reached and the polymer becomes molten. At the temperature interval between T_{g} and Tₘ the polymer exists in the rubbery state and it is possible to shape the polymer by applying pressure on it. It is this characteristic that is utilized when applying the hot embossing technique. One way of employing a hot embossing step may be to bring a hot embossing stamp into contact with the multi-layered film, which is heated to a temperature above the T_{g} (e.g. the T_{g} of the at least one of the layers to be embossed) and pressure is applied to the embossing stamp, forcing the protrusions of the stamp into the multi-layered film. After the stamp has been fully pressed into the multi-layered film, it is cooled to a temperature below T_{g}. The decrease in temperature below the T_{g} stiffens the multi-layered film while retaining the shape made by the protrusions of the stamp. Once the multi-layered film stiffens the stamp may be removed.

In some embodiments of the present invention, wherein the one or more layers to be embossed layer is made out of a material having a T_{g} of between −100 to 100° C. and a Tₘ between 35 and 250° C., and where T_{g}<Tₘ.

The melting temperature (Tₘ) of the barrier layer may be is more than 20° C., such as more than 30° C., more than 35° C., more than 37° C., more than 40° C., more than 50° C., more than 60° C., more than 70° C., more than 90° C., more than 100° C., more than 120° C. In some embodiments the Tₘ is less than 350° C., such as less than 300° C., less than 250° C., less than 200° C., less than 150° C., less than 120° C. In some embodiments the Tₘ range is 20-350° C., such as 60-350° C., 70-250° C., 80-250° C.

The embossing temperature may be between the T_{g} and the Tₘ of the one or more layers to be embossed. In some embodiments the embossing temperature will be less than ½*(T_{g}+Tₘ), which may require more force and time to prepare a micro-structure. In some embodiments the embossing temperature will be more than ½*(T_{g}+Tₘ), which may require less force and time to prepare a micro-structure.

The embossing stamp may have one or more protrusions as opposed to being flat. These protrusions define one or more cavities that allows for the generation of the one or more micro-structures, wherein the depth of the one or more of the protrusions of the embossing stamp defines the outer shape of the one or more micro-structures.

In some embodiments the embossing stamp may be a through-hole embossing stamp, which is a stamp where there is at least one hole that goes all the way through the embossing stamp.

In some embodiments of the present invention, the embossing stamp is a closed embossing stamp. A closed embossing stamp is a stamp, which does not have a hole that goes all the way through the embossing stamp. In some embodiments of the present invention, it is preferable to have a closed embossing stamp, as it provides for versatility in the outer shape, i.a. the possibility of preparing microstructures having a non-flat top, such as for example micro-containers.

The depth of the one or more protrusions of the embossing stamp should be substantially as high, and preferably higher than the thickness of the one or more layer(s) to be embossed, which will allow the embossing stamp to completely penetrate the one or more layers to be embossed, as shown e.g. in FIG. 11.

In some embodiments of the present invention, the depth of the one or more of the protrusions of the embossing stamp that defines the outer shape of the one or more microstructures should be lower than the combined heights of the multi-layered film comprising one or more elastically or plastically deformable layers and one or more layers to be embossed, in order to avoid also penetrating the elastically or plastically deformable layers and reducing the risk that these layers inadvertently becomes trapped in the embossing stamp together with the one or more layers to be embossed.

The demoulding of the one or more microstructures from the one or more cavities in the embossing stamp may be done by bonding the one or more micro-structures onto a release layer.

In some embodiments the elastically or plastically deformable layer is the release layer itself, in that it has been selected and/or treated in order to increase the stiction to the one or more layers to be embossed.

In some embodiments of the present invention, the elastically or plastically deformable layer is subjected to an oxygen plasma treatment prior to depositing the one or more layer(s) to be embossed. The oxygen plasma treatment temporarily increases the stiction of the elastically or plastically deformable layer. Accordingly, the stiction of the elastically or plastically deformable layer may be increased prior to depositing of the one or more layers to be embossed. This increased stiction results in the micro-structures adhering to the elastically or plastically deformable layers when removing the embossing stamp, thereby performing the embossing and demoulding in one concerted step. After some time, the increased stiction of the oxygen plasma treated elastically or plastically deformable layer will wear off, and the micro-structures can be released without further treatment.

Oxygen plasma treatment may be employed on materials such as e.g. silicones, hydrogels, gels in their elastic regime and rubbers. Example 8 shows hot embossing of poly lactic acid on plasma activated PDMS elastic layer.

The stiction of the release layer may also be improved by other means, such as for example oxygen plasma treatment, chemical surface modification/functionalization, UV treatment, ozone treatment, or deposition of an adhesion promoter.

In some embodiments of the present invention, where the micro-structures are stuck in the embossing stamp, the one or more microstructures may be demoulded from in the one or more cavities in the embossing stamp by exchanging the substrate with the multi-layered film comprising one or more elastically or plastically deformable layers and one or more embossed layers with a substrate having a release layer, and then applying the embossing stamp to the substrate having a release layer.

This demoulds the micro-structures from the cavities of the stamp in a two-stamp process, which allows for a more versatile selection of the elastically or plastically deformable layer and the release layer.

As described above, the release layer may be materials such as e.g. silicones, hydrogels, gels in their elastic regime and rubbers, which may or may not have been treated to increase stiction, e.g. by chemical surface modification/functionalization, UV treatment, ozone treatment, plasma oxygen treatment, or deposition of an adhesion promoter.

In some embodiments of the present invention, the bonding to the release layer may be done using thermal bonding, UV bonding or chemical bonding, tape adhesive bonding, ultrasonic welding, laser welding, or solvent bonding.

In some embodiments of the present invention, the release layer is selected from the list consisting of: tape, water soluble polymer layers, or any layer, which may be dissolved without harming/dissolving the micro-structures. FIG. 12 shows an example of a release layer, which is dissolvable in a liquid, such as a water soluble hydrogel, thereby releasing the micro-structures upon dissolution. Examples of water soluble layers are polyacrylic acid, polyisocyanates, cationic polyelectrolytes, Natural (industrial gums), starch, chitosan, polysaccharides, polyethylene glycol, polyvinyl alcohol, alignate, agar, methylcellulose derivatives, polyvinyl pyrrolidone, polyacrylamides, polyethyleneglycol, dextran, polyamines, gelatin, casein, hyaluronic acid, or Eudragits.

Eudragits may be used as enteric coatings, and they are co-polymers comprising methyl methacrylate and ethyl acrylate.

In some embodiments the embossing stamp is made out of a material that has low stiction, such as e.g. anodized aluminium, ceramics or silicone; or is coated with a material that has a low stiction.

In some embodiments of the present invention, the embossing stamp is coated with a stiction reducing layer, selected from the list consisting of: fluoropolymers, such as polytetrafluoroethylene (PTFE), fluorosilanes, such as per-fluoro-decyl-trichlorosilane (FDTS).

In some embodiments, such as shown for example in FIG. 13, the stiction of the release layer is increased, and the stiction of the embossing stamp is reduced.

Accordingly, in some embodiments of the present invention, the embossing stamp having a first stiction with regards to the one or more layer(s) to be embossed, the elastically or plastically deformable layer having a second stiction with regards to the one or more layer(s) to be embossed, characterized in that the first stiction is lower than the second stiction.

The micro-container may have many different shapes, as defined by the protrusions of the embossing stamp.

In some embodiments of the present invention, the embossing stamp has protrusions that allows for the generation of one or more micro-container(s), wherein the bottom of the one or more micro-container(s) is flat, curved, such as a hemisphere, or is a corner or part of a geometrical figure.

In some embodiments of the present invention, the embossing stamp has protrusions that allows for the generation of one or more microstructure(s) having an outer shape, which resembles a shape selected from the list consisting of: a circular and/or elliptical cylinder, a circular and/or elliptical cone, a circular and/or elliptical half-capsule, a circular and/or elliptical conical frustum, a wedge, a pyramid, a cube, a rectangular cuboid, a prism such as a triangular, pentagonal, hexagonal, heptagonal, octagonal, or polygonal prism.

In some embodiments the microstructure will have five or less throughholes, such as one throughhole or less than one through-hole. For example, the micro-structure may be a gear, which in the middle has a throughhole, or it may for example be a ring or other geometrical figure or other structure with one or more throughhole(s) in it.

In some embodiments of the present invention, the microstructure is without through-holes.

Many copies of the protrusions that generate the micro-structures may be present on one stamp, which allows for the generation of many micro-structures in one stamping process. Also the embossing stamp may be configured to be used in a roll-to-roll setup, which enables the continuous production of micro-structures.

In some embodiments of the present invention, the protrusions on the embossing stamp allows the manufacture of at least 6000 micro-structures, such as e.g. at least 60000 micro-structures in a single hot embossing step, e.g. such as a single revolution of a roll-stamp.

In some embodiments of the present invention, the embossing stamp has protrusions that allows for the generation of one or more micro-structure(s), wherein each individual microstructure has an outer shape comprising a width and a height of ≦9000 μm, such as ≦5000 μm, ≦2500 μm, ≦1000 μm, ≦900 μm, ≦800 μm, ≦700 μm, ≦600 μm, ≦500 μm, ≦400 μm, ≦300 μm, ≦250 μm, ≦200 μm, ≦150 μm, ≦100 μm, ≦50 μm.

In some embodiments of the present invention, the microstructure is a micro-container. A micro-container is a receptacle which can receive and hold something, such as e.g. an active ingredient. The micro-container may have one or more openings. In some embodiments the micro-container has one opening (or more than one opening, where all the openings are all on one side, as e.g. the case of some multicompartmented micro-containers), which means that the container may release its contents, i.e. the active ingredient, in an essentially unidirectional manner through the opening in the micro-container. In some embodiments of the present invention, each individual micro-container has a width and a height of ≦9000 μm, such as ≦5000 μm or less than 500 μm. In some embodiments the micro-containers may have a width-to-height ratio (w/h) of ≦3 to ensure a structure for an improved unidirectional release.

In some embodiments the micro-container has a width (w) to height (h) ratio (w/h) of ≦10, such as or ≦3;

The micro-containers may have many different dimensions. For instance it may be a shallow micro-container, 30 μm high and 300 μm wide corresponding to a width to height ratio of 10; or it may be a moderately shallow micro-container, 50 μm high and 300 μm wide corresponding to a width to height ratio of 6; or it may be a micro-container, 50 μm high and 150 μm wide corresponding to a width to height ratio of 3.

In some embodiments the micro-container has an outer diameter of 200-500 μm, and may have a height of 2-70 μm. In some embodiments the wall thickness may be larger than 5 μm to increase geometrical stability and reduce buckling. In some embodiments the micro-container has a compartment size diameter of between 20-350 μm.

When describing the embodiments of the present invention, the combinations and permutations of all possible embodiments have not been explicitly described. Nevertheless, the mere fact that certain measures are recited in mutually different dependent claims or described in different embodiments does not indicate that a combination of these measures cannot be used to advantage. The present invention envisages all possible combinations and permutations of the described embodiments.

The terms “comprising”, “comprise” and “comprises” herein are intended by the inventors to be optionally substitutable with the terms “consisting of”, “consist of” and “consists of”, respectively, in every instance.

### EXAMPLES

### Example 1

### Spin Coating of Polycaprolactone/Furosemide on Silicon Wafer (Core Layer)

A polymer-drug core layer was fabricated by spin coating of a solution of polycaprolactone (PCL) and the diuretic drug furosemide on a standard 4-inch single crystal (SC) silicon wafer supplied by Okmetic (Vantaa, Finland). All the chemicals were obtained from Sigma-Aldrich and were used as recieved. A solution consisting of 20 mL dichloromethane, 40 mL acetone, 8 g PCL and 2 g furosemide was prepared and kept on a hotplate at a temperature of 50° C. for at least 48 h. During heating constant magnetic stirring was applied to achieve a homogeneous polymer solution. The solution was cooled to room temperature (RT) before spin coating. The spin coating was performed on an RC8 spin coater (Karl Suss, Lyon, France). The polymer-drug solution was dispensed on a silicon wafer rotating at 200 rpm. The wafer is then accelerated with 2000 rpm/s to the final spin speed of 1000 rpm which was maintained for 60 s. The resulting film thickness as measured after 48 h of drying at RT in a fumehood was 15 μm.

### Example 2

### Spin Coating of PCL on PCL/Furosemide Layer (Barrier Layer)

A polymer barrier layer was deposited onto the polymer-drug core layer by spin coating of a solution of PCL. The polymer solution consisted of 8 g PCL in 40 mL dichloromethane. The preparation of the polymer solution and the spin coating followed an identical procedure as described in example 1 for the polycaprolactone/furosemide layer. The resulting thickness of the barrier layer was 10 μm.

### Example 3

### Fabrication of Embossing Stamp

For hot embossing, a stamp with vertical or near vertical sidewalls may be preferable. Negative slopes are typically avoided because of the risk of trapping the polymer in the stamp, and also because it hinders the removal of the stamp after completed processing. For the embossing of the micropatches a fabrication process for nickel stamps with positive sidewall slopes is developed. This should support the enclosure of the core layer by the barrier layer during the embossing process.

The stamp fabrication is based on electroplating of nickel on a silicon template followed by removal of the template. First, 500 nm of wet silicon oxide were deposited on a standard 4-inch SC silicon wafer during 50 min in a LPCVD furnace (Tempress, MD Vaassen, the Netherlands) at 1100° C. Next, the wafer was coated with hexamethyldisiloxane (HMDS) and a 1.5 μm thick film of positive photoresist AZ5214e (Clariant GmbH, Wiesbaden, Germany) was applied by spin coating on a Maximus 804 spin coating equipment (ATMsse GmbH, Singen, Germany). The photoresist is soft-baked for 90 seconds at 90° C. on a hotplate and exposed through a photolithographic mask (Delta Mask B.V., GJ Enschede, the Netherlands) in hard contact mode with a dose of 35 mJ/cm² in a MA6/BA6 UV mask aligner (Karl-Suss, Garching, Germany) equipped with an i-line filter (365 nm, 20 nm FWHM). The exposed photoresist was developed for 60 s in AZ351 developer (Clariant) in a (1:5) dilution with water. The photoresist served as an etch mask for the patterning of the underlying oxide layer. The etching of the silicon oxide was performed in BHF for 10 min followed by stripping of the photoresist mask in acetone. The patterned silicon oxide is the mask for the etching of the silicon bulk material by deep reactive ion etching (DRIE) using a Pegasus DRIE system (STS, Newport, UK). The etching was performed with SF₆, O₂ and Ar at gas flows of 180 sccm, 160 sccm and 160 sccm respectively. The coil power was set to 2800 W and the processing temperature was set to 10° C. The pressure is linearly decreased from 230 mTorr to 90 mTorr and the platen power is linearly increased from 170 W to 215 W for the duration of the process to obtain a positive sidewalls slope [Li et al., J. Micromech. Microeng., 18 (2008) 125023]. The final etch depth is 58 μm. After the DRIE, the silicon oxide etch mask was removed in BHF. The seed layer for the electroplating process consisted of 20 nm Ti and 300 nm Au, which was deposited in a CMS-18 sputter system (Kurt. J. Lesker Company, Jefferson Hills, USA). Next, 500 μm of Ni was electroplated on the metal coated template on a microform.200 Nickel electroplating machine (Technotrans, Sweden) with a plating bath of aqueous nickel sulfamate, boric acid and sulfamic acid at 51° C. and pH 3.5-3.8. The current was linearly increased to 0.5 A during 15 min followed by ramping to 1.5 A for additional 15 min. The current was maintained at 1.5 A for 30 min and increased to the final value of 6.5 A during 15 min. There, the electroplating was continued for approximately 3 h until a final setpoint charge of 26.8 Ah was reached. The electroplating step was followed by the removal of the silicon template in 28 wt % KOH at 80° C. during approximately 10 h resulting in a Ni stamp coated with Au.

A stamp (see FIG. 4) with a mesh of quadratic structures of 300×300 μm² was designed and fabricated for embossing in the two layered polymer stack described above. FIG. 4 shows SEM-micrographs of the nickel stamp. The protrusions are 37 μm wide at the base and 27 μm wide at the top. The height of the protrusions is 58 μm and the period is 300 μm.

### Example 4

### Hot Embossing of Furosemide and Polycaprolactone Multilayer

For the hot embossing, the multi-layered film on the silicon wafer described in example 2 and the stamp described in example 3 were placed on top of each other in a 520 Hot Embosser (EV Group, Austria). The system was closed and a vacuum was applied. The hot embossing was performed for 1 h at a pressure of 1.9 MPa and a temperature of 60° C.

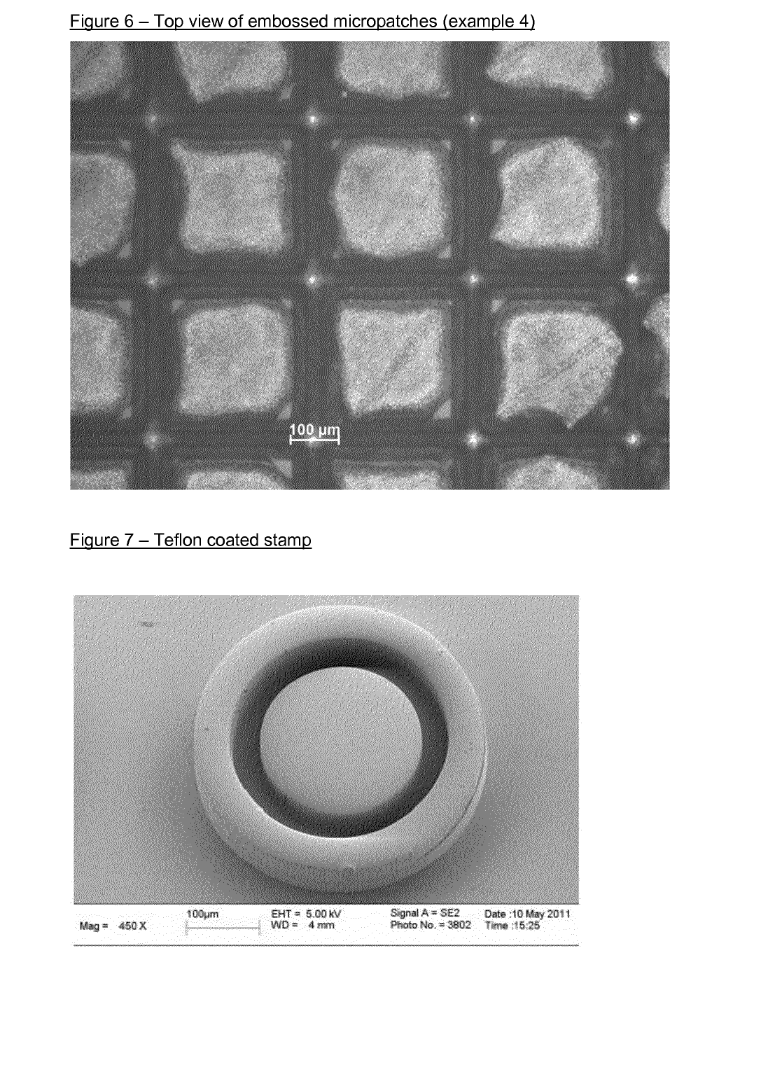

FIG. 6 shows a top view of embossed micropatches consisting of a drug core layer with a PCL barrier layer on top. The PCL polymer generally appears transparent (shown as black in the figure) while the drug matrix appears white after the embossing. The images indicate that the core layer with the drug is confined to the center of the patch after embossing and that the barrier layers enclose the entire 300 μm square.

### Example 5

### Spin Coating and Activation of PMDS on Silicon Wafer (Elastically Deformable Layer)

A fresh standard 4-inch single crystal (SC) silicon wafer (Okmetic, Vantaa, Finland) is stocked out. The wafer is processed without any pretreatment. Then a silicone elastomer kit (Sylgard® 184, Dow Corning) is used to prepare the PDMS layer on the silicon wafer. The prepolymer and the curing agent are mixed in 10:1 ratio. The mixture is kept in vacuum for 20 minutes to remove all the bubbles. After that the mixture is dispensed on the Si wafer for spin coating. The spin coating is done at the final speed of 500 rpm for 90 seconds on WS-650-15 Spin coater (Laurell Technologies). After spin coating, the PDMS is cured at 90° C. for 15 min. The PDMS is crosslinked forming a stable elastic layer with a thickness of 110 microns.

In order to activate the PDMS layer, it is treated in oxygen plasma for 90 seconds in home-made plasma-chamber.

### Example 6

### Spin Coating Poly Lactic Acid on PMDS Layer (Layer to be Embossed)

Immediately after the the oxygen plasma treatment, poly(lactic acid) (PLA) is deposited in order to avoid stiction of dust particles to the activated PDMS surface layer.

A PLA layer is fabricated by spin coating of a solution of PLA and dichloromethane on the PDMS coated Si wafer. All the chemicals are obtained from Sigma-Aldrich and used as received. A solution consisting of 60 mL dichloromethane and 14.47 g PCL is prepared and kept on a hotplate at a temperature of 50° C. for at least 48 h. During heating constant magnetic stirring was applied to achieve a homogeneous polymer solution. The solution is cooled to room temperature before spin coating. The spin coating is performed on the WS-650-15 Spin coater (Laurell Technologies). The polymer-drug solution is dispensed on a silicon wafer rotating at 200 rpm. The wafer is then accelerated with 1000 rpm/s to the final spin speed of 500 rpm which is maintained for 60 s. The resulting film thickness measured after 2 h of degassing in a fumehood is 75-80 μm.

### Example 7

### Fabrication of Embossing Stamp

Here, a process for the fabrication of cylindrical micro-containers is described. The stamp fabrication is based on electroplating of nickel on a silicon template followed by removal of the template.

First, 500 nm of wet silicon oxide are deposited on a standard 4-inch SC silicon wafer during 50 min in a LPCVD furnace (Tempress, MD Vaassen, the Netherlands) at 1100° C.

Next, a first step of photolithography is performed to allow patterning of the silicon oxide. For this purpose, the wafer is coated with hexamethyldisiloxane (HMDS) and a 1.5 μm thick film of positive photoresist AZ5214e (Clariant GmbH, Wiesbaden, Germany) is applied by spin coating on a Maximus 804 spin coating equipment (ATMsse GmbH, Singen, Germany). The photoresist is soft-baked for 90 s at 90° C. on a hotplate and exposed through a photolithographic mask (Delta Mask B. V., GJ Enschede, the Netherlands) in hard contact mode with a dose of 35 mJ/cm² in a MA6/BA6 UV mask aligner (Karl-Suss, Garching, Germany) equipped with an i-line filter (365 nm, 20 nm FWHM).

The exposed photoresist was developed for 60 s in AZ351 developer (Clariant) in a (1:5) dilution with water. The photoresist serves as etch mask for the patterning of the underlying oxide layer. The etching of the silicon oxide is performed in BHF for 10 min followed by stripping of the photoresist mask in Acetone. A second step of photolithography identical to the one described above is performed consisting of HMDS, spin coating, UV exposure with a different photolithographic mask and development.

Next, two steps of deep reactive ion etching (DRIE) of the silicon bulk material are performed in a Pegasus DRIE system (STS, Newport, UK). A BOSCH process at 0° C. is used, switching between a passivation cycle with a gas flow of 150 sccm C₄F₈ (pressure 20 mTorr, coil power 2000 W, platen power 0 W, cycle time 2 s) and an etching cycle with gas flows of 275 sccm SF₆ and 5 sccm O₂ (26 mTorr, 2500 W, 35 W, 2.4 s). In the first etching step to a depth of 20 μm, the photoresist layer serves as etch mask to obtain the pattern corresponding to the outer circumference of the containers. After this step, the photoresist is removed in stripped in acetone followed by cleaning in oxygen plasma. In the second etching step to a depth of 80 μm, the patterned silicon oxide serves as etch mask to obtain the pattern corresponding to the container reservoir. After the DRIE, the silicon oxide etch mask is removed in BHF. The seed layer for the electroplating process consisting of 20 nm Ti and 300 nm Au is deposited in a CMS-18 sputter system (Kurt. J. Lesker Company, Jefferson Hills, USA). Next, 500 μm of Ni are electroplated on the metal coated template on a microform.200 Nickel electroplating machine (Technotrans, Sweden) with a plating bath of aqueous nickel sulphamate, boric acid and sulfamic acid at 51° C. and pH 3.5-3.8. The current is linearly increased to 0.5 A during 15 min followed by ramping to 1.5 A during additional 15 min. The current is maintained at 1.5 A for 30 min and increased to the final value of 6.5 A during 15 min. There, the electroplating is continued for approximately 3 h until a final setpoint charge of 26.8 Ah is reached. The electroplating step is followed by the removal of the silicon template in 28 wt. % KOH at 80° C. during approximately 10 h resulting in a Ni stamp coated with Au.

A stamp with 4×4 array of 20×20 patches of microcontainers is designed for making drug-loaded reservoirs for oral drug delivery. FIG. 2 shows SEM micrograph of a Ni stamp feature for the definition of one container. In total, there are 6400 containers per stamp. An individual unit consists of two parts, an inner disc and an outer ring structure. The total width of the containers is 300 μm. The wall and the outer ring thicknesses are 40 μm and 30 μm, respectively. The stamp is fabricated as described above and then coated with teflon. The height of the outer ring is 80 μm and the one of the inner disc is 65 μm.

### Example 8

### Hot Embossing of Poly Lactic Acid Layer on Plasma Activated PMDS Elastic Layer

The PLA on PDMS stack is embossed with the Ni stamp for 1 h at a temperature of 120° C. and a pressure of 1.9 MPa [J. Nagstrup, S. Keller, K. Almdal, A. Boisen, Microelectronic Engineering, 88(8), 2342-2344 (2011)] The viscoelastic under layer of PDMS deforms against the stamp and pushes the polymer into the cavities of the stamp. Due to this enhanced deformation, the residual layer is broken and the micro-containers are punched out of the PLA film. Next, Ni the stamp and the Si wafer are demoulded. The adhesion of the PLA to the plasma activated PDMS is higher than the adhesion between the PLA and the stamp and the punched PLA micro-containers are demoulded from the stamp and left on the PDMS coated Si wafer. The PLA micro-containers are released from the PDMS layer after a few days of storage due to a decrease of the adhesion between PLA and PDMS.

### Example 9

### Hot Embossing of Poly Lactic Acid Layer on PMDS Elastic Layer Without Plasma Activation

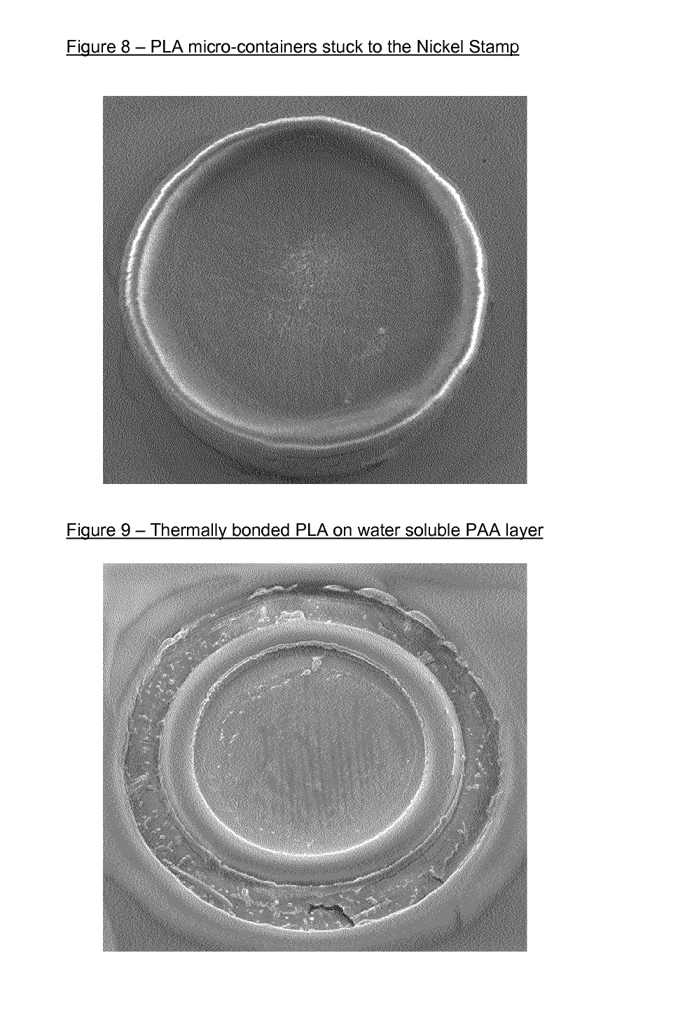

The PLA on PDMS stack of example 5, where the PDMS has not undergone plasma activation is subjected to an embossing step as described in example 8. This results in the individual micro-containers being stuck in the stamp, as shown in FIG. 8. At this stage, a polymer film with through holes is left on the Si wafer.

### Example 19

### Demolding of the Microstructures from the Embossing Stamp through Bonding to a Release Layer of Poly(Acrylic Acid)

First, a standard Si wafer is taken and then at the spin speed of 500 rpm for 90 sec, a 20 μm thick film of poly(acrylic acid) (PAA) is coated on a Si wafer. After that, the stamp with the PLA microcontainers is thermally bonded to this PAA layer (FIG. 9). The bonding is done for 1 h at a temperature of 120° C. and a pressure of 1.9 MPa. The stamp is removed and the containers remain on the PAA coated wafer. Free-floating microcontainers are obtained by dissolution of the PAA layer in MIlli Q water.

1. A method for manufacturing one or more micro-container(s) containing an active ingredient comprising the steps of:
a) preparing a multi-layered film comprising at least a core layer and a barrier layer, wherein the core layer comprises at least the active ingredient or wherein the core layer is configured to accept the active ingredient;
b) subjecting the multi-layered film to a hot embossing step using an embossing stamp having protrusions that allows for generation of the one or more micro-container(s) containing an active ingredient or containing a core layer that is configured to accept the active ingredient such that the barrier layer partially encloses the core layer;
c) when the core layer is configured to accept the active ingredient—providing the active ingredient to the core layer.

2. Method according to claim 1, wherein the multi-layered film is deposited on a handling substrate, and comprise the following sequence of deposited layers on top of the handling substrate:
i) a release layer;
ii) optionally an enteric layer;
iii)optionally a mucoadhesive layer;
iv) a core layer comprising at least the active ingredient or a core layer configured to accept the active ingredient;
v) a barrier layer.

3. Method according to claim 1, wherein the embossing stamp has protrusions that allows for the generation of one or more micro-container(s), wherein the bottom of the one or more micro-container(s) is flat, curved, such as a hemisphere, or is a corner of a geometrical figure.

4. Method according to claim 1, wherein the embossing stamp has protrusions that allows for the generation of one or more micro-container(s) having an outer shape, which resembles a shape selected from the list consisting of: a circular and/or elliptical cylinder, a circular and/or elliptical cone, a circular and/or elliptical half-capsule, a circular and/or elliptical conical frustum, a wedge, a pyramid, a cube, a rectangular cuboid, a prism such as a triangular, pentagonal, hexagonal, heptagonal, octagonal, or polygonal prism.

5. Method according to claim 1, wherein the active ingredient is selected from the list consisting of: small organic molecules, proteins, peptides, vitamins, antibodies, antibody fragments, vaccines, RNA, DNA, antibiotics or combinations thereof.

6. Method according to claim 1, wherein the barrier layer is made out of a material having a T_{g} of between −100 to 100° C. and a Tₘ between 35 and 250° C., and where T_{g}<Tₘ.

7. Method according to claim 1, wherein the barrier layer is made out of polycaprolactone (PCL), polylactic acid (PLA), polyglycolic acid (PGA), hydroxypropylmethyl cellulose (HPMC), polymethacrylate (PMMA), Eudragits (Poly(methacylic acid-co-methyl methacrylate), ethyl cellulose (EC), polyvinyl alcohol (PVA), polyvinylpyrollidone (PVP), polyethylene glycol (PEG), polyethylene glycol methacrylate (PEGMA), polyethylene glycol dimethacrylate (PEGDMA), poly(lactic-co-glycolic acid) (PGLA), polyacrylic acid (PAA), or co-polymers of at least one of the above polymers or monomeric units in the above polymers.

8. Method according to claim 1, wherein the embossing stamp has protrusions that allows for the generation of one or more micro-container(s), wherein each of the micro-containers has an outer shape comprising a width and a height of ≦9000 μm, such as ≦5000 μm, ≦2500 μm, ≦1000 μm, ≦900 μm, ≦800 μm, ≦700 μm, ≦600 μm, ≦500 μm, ≦400 μm, ≦300 μm, ≦250 μm, ≦200 μm, ≦150 μm, ≦100 μm, ≦50 μm.

9. Micro-container obtainable according to claim 1.

10. A micro-container (101) containing an active ingredient, and having an outer shape comprising a bottom (102), one or more sides (103) and an opening (104), where the bottom (102) and one or more sides (103) have one or more layer thicknesses (110, 111, 112), and defines a volume, the volume being at least partially filled with a core material comprising at least one active ingredient; the micro-container having a width (w) to height (h) ratio (w/h) of ≦3; characterized in that the average layer thickness of the sides (111, 112) are less than the average layer thickness of the bottom (110) of the micro-container.

11. Micro-container according to claim 10, characterized in that the layer thickness of part of the sides that are closer to the opening of the micro-container (112) has a layer thickness smaller than the layer thickness of the sides closer to the bottom of the micro-container (111) and/or smaller than the layer thickness of the bottom of the micro-container (110).

12. Micro-container according to claim 10, wherein the bottom is flat, curved, such as a hemisphere, or is a corner of a geometrical figure

13. Micro-container according to claim 10, wherein the active ingredient is selected from the list consisting of: small organic molecules, proteins, peptides, vitamins, antibodies, antibody fragments, vaccines, RNA, DNA, antibiotics or combinations thereof.

14. Micro-container according to claim 11, wherein the micro-container is made out of one or more of the following: polycaprolactone (PCL), polylactic acid (PLA), polyglycolic acid (PGA), hydroxypropylmethyl cellulose (HPMC), polymethacrylate (PMMA), Eudragits (Poly(methacylic acid-co-methyl methacrylate), ethyl cellulose (EC), polyvinyl alcohol (PVA), polyvinylpyrollidone (PVP), polyethylene glycol (PEG), polyethylene glycol methacrylate (PEGMA), polyethylene glycol dimethacrylate (PEGDMA), poly(lactic-co-glycolic acid) (PGLA), polyacrylic acid (PAA), or co-polymers of at least one of the above polymers or monomeric units in the above polymers.

15. Micro-container according to claim 10, having a width and a height of ≦9000 μm, such as ≦5000 μm, ≦2500 μm, ≦1000 μm, ≦900 μm, ≦800 μm, ≦700 μm, ≦600 μm, ≦500 μm, ≦400 μm, ≦300 μm, ≦250 μm, ≦200 μm, ≦150 μm, ≦100 μm, ≦50 μm.

16. A method for manufacturing one or more microstructure(s) having an outer shape comprising the steps of:
a) providing an elastically or plastically deformable layer on a substrate that does not form part of the one or more microstructure(s);
b) providing one or more layer(s) to be embossed on top of the elastically or plastically deformable layer;
c) subjecting the layers under steps a) and b) to a hot embossing step using a rigid embossing stamp having one or more protrusions defining one or more cavities that allows for generation of the one or more microstructures, wherein the depth of the one or more of the protrusions of the embossing stamp that defines the outer shape of the one or more microstructures is higher than the thickness of the one or more layer(s) to be embossed under step b) thus allowing the embossing stamp to penetrate all the way through the one or more layer(s) to be embossed under step b);
d) demoulding the one or more microstructures from in the one or more cavities in the embossing stamp by bonding the one or more microstructures onto a release layer.

17. The method according to claim 16, wherein under c), wherein the depth of the one or more of the protrusions of the embossing stamp that defines the outer shape of the one or more microstructures is lower than the combined heights of the layers under a) and b).

18. The method according to claim 16, wherein the microstructure has a non-flat top surface.

19. The method according to claim 16, wherein the microstructure is a micro-container.

20. The method according to claim 16, wherein the microstructure is without through-holes.

21. The method according to claim 16, wherein the embossing stamp is a closed embossing stamp.

22. The method according to claim 16, wherein under step d) the one or more microstructures are demoulded from in the one or more cavities in the embossing stamp by exchanging the substrate with the layers a) and b) with a substrate having a release layer, and then applying the embossing stamp to the substrate having a relase layer.

23. The method according to claim 16, wherein the release layer is selected from the list consisting of: tape, water soluble polymer layers.

24. The method according to claim 16, wherein the bonding is thermal bonding, UV bonding or chemical bonding, tape adhesive bonding, ultrasonic welding, laser welding, solvent bonding.

25. The method according to claim 16, wherein the embossing stamp having a first stiction with regards to the one or more layer(s) to be embossed, the elastically or plastically deformable layer having a second stiction with regards to the one or more layer(s) to be embossed, characterized in that the first stiction is lower than the second stiction.

26. The method according to claim 25, wherein the elastically or plastically deformable layer is subjected to an oxygen plasma treatment prior to depositing the one or more layer(s) to be embossed.

27. The method according to claim 25, wherein the embossing stamp is coated with a stiction reducing layer, selected from the list consisting of: fluoropolymers, such as polytetrafluoroethylene (PTFE), fluorosilanes, such as per-fluoro-decyl-trichlorosilane (FDTS).

28. The method according to claim 16, wherein the elastically or plastically deformable layer is PDMS.

29. Method according to claim 16, wherein the embossing stamp has protrusions that allows for the generation of one or more microstructure(s) having an outer shape, which resembles a shape selected from the list consisting of: a circular and/or elliptical cylinder, a circular and/or elliptical cone, a circular and/or elliptical half-capsule, a circular and/or elliptical conical frustum, a wedge, a pyramid, a cube, a rectangular cuboid, a prism such as a triangular, pentagonal, hexagonal, heptagonal, octagonal, or polygonal prism.

30. Method according to claim 16, wherein the embossing stamp has protrusions that allows for the generation of one or more microstructure(s), wherein each individual microstructure has an outer shape comprising a width and a height of ≦9000 μm, such as ≦5000 μm, ≦2500 μm, ≦1000 μm, ≦900 μm, ≦800 μm, ≦700 μm, ≦600 μm, ≦500 μm, ≦400 μm, ≦300 μm, ≦250 μm, ≦200 μm, ≦150 μm, ≦100 μm, ≦50 μm.

31. Method according to claim 1, wherein under a) the multi-layered film is deposited on an elastically deformable layer, which does not form part of the one or more micro-container(s), and wherein under b) the depth of the protrusions of the embossing stamp that defines the outer shape of the one or more micro-containers is higher than the thickness of the multi-layered film under step a) thus allowing the embossing stamp to penetrate all the way through the multi-layered film under step a) and into the elastically deformable layer.

32. Method according to claim 31, additionally comprising step d) demoulding the one or more micro-containers from in the one or more cavities in the embossing stamp by bonding the one or more micro-containers onto a release layer.

33. The method according to claim 31, wherein under c), wherein the depth of the one or more of the protrusions of the embossing stamp that defines the outer shape of the one or more micro-containers is lower than the combined heights of the layers under a) and b).

34. The method according to claim 31, wherein the micro-container has a non-flat top surface.

35. The method according to claim 31, wherein the embossing stamp is a closed embossing stamp.

36. The method according to claim 32, wherein under step d) the one or more micro-containers are demoulded from in the one or more cavities in the embossing stamp by exchanging the substrate with the layers a) and b) with a substrate having a release layer, and then applying the embossing stamp to the substrate having a relase layer.

37. The method according to claim 32, wherein the release layer is selected from the list consisting of: tape, water soluble polymer layers.

38. The method according to claim 32, wherein the bonding is thermal bonding, UV bonding or chemical bonding, tape adhesive bonding, ultrasonic welding, laser welding, solvent bonding.

39. The method according to claim 31, wherein the embossing stamp having a first stiction with regards to the one or more layer(s) to be embossed, the elastically or plastically deformable layer having a second stiction with regards to the one or more layer(s) to be embossed, characterized in that the first stiction is lower than the second stiction.

40. The method according to claim 31, wherein the elastically or plastically deformable layer is subjected to an oxygen plasma treatment prior to depositing the one or more layer(s) to be embossed.

41. The method according to claim 31, wherein the embossing stamp is coated with a stiction reducing layer, selected from the list consisting of: fluoropolymers, such as polytetrafluoroethylene (PTFE), fluorosilanes, such as per-fluoro-decyl-trichlorosilane (FDTS).

42. The method according to 31, wherein the elastically or plastically deformable layer is elastical, and is PDMS.

43. The method according to claim 31, wherein the embossing stamp has protrusions that allows for the generation of one or more microstructure(s) having an outer shape, which resembles a shape selected from the list consisting of: a circular and/or elliptical cylinder, a circular and/or elliptical cone, a circular and/or elliptical half-capsule, a circular and/or elliptical conical frustum, a wedge, a pyramid, a cube, a rectangular cuboid, a prism such as a triangular, pentagonal, hexagonal, heptagonal, octagonal, or polygonal prism.

44. The method according to claim 31, wherein the embossing stamp has protrusions that allows for the generation of one or more micro-container(s), wherein each individual micro-container has an outer shape comprising a width and a height of ≦700 μm, ≦600 μm, ≦500 μm, ≦400 μm, ≦300 μm, ≦250 μm, ≦200 μm, ≦150 μm, ≦100 μm, ≦50 μm.
